(19) United States
(12) Patent Application Publication
(10) Pub. No.: US 2026/0338521 A1
(43) Pub. Date: Oct. 29, 2026

(54) METHODS AND SYSTEMS FOR ESTIMATING LOCATION OF A PROJECTILE LAUNCH

(71) Applicant: ELTA SYSTEMS LTD., Ashdod (IL)

(72) Inventors: Gonen Moshe ETTINGER, Efrat (IL); Hen PINTO, Tel Aviv (IL); Noam FRENKEL, Karmey Yosef (IL); Elyahu PERL, Kiryat Ono (IL); Erez SHARON, Karmei Yosef (IL)

(21) Appl. No.: 19/111,581

(22) PCT Filed: Sep. 13, 2023
(86) PCT No.: PCT/IL2023/050991

§ 371 Date: Mar. 13, 2025

(30) Foreign Application Priority Data
Sep. 13, 2022 (IL) 296482

(51) Int. Cl. F41G 3/14; G01C 23/00

(52) U.S. Cl. CPC F41G 3/147; G01C 23/00

(57) ABSTRACT

There are provided systems and methods enabling estimating a location of a projectile launch, and comprising performing, by one or more processing circuitries: obtaining, from an imaging device, data D\hat{ }lash informative of an optical event associated with the projectile launch, obtaining, from acoustic sensors, acoustic data, wherein the acoustic data includes data Dshnrkwm,ps informative of shock waves generated by a motion of the projectile, and using Dj-lash and Dshockwaves to estimate the location of the projectile launch.

### PRIORITY

The present patent application claims priority of IL 295482, filed on Sep. 13, 2022.

### TECHNICAL FIELD

The presently disclosed subject matter relates to the detection of a projectile launch. In particular, it relates to the determination of data informative of the projectile launch, such as (but not limited to) the location of the projectile launch.

### BACKGROUND

In the prior art, acoustic systems have been used to determine the location of a projectile launch. However, these prior art systems suffer from several drawbacks, which include, inter alia, a limited range estimation accuracy, a high sensitivity to environmental noise, an operability which is limited only to certain types of platforms (lightweight and/or silent platforms), an inoperability to detect a shooter with a silencer, inaccuracy in adverse conditions, etc.

References considered to be relevant as background to the presently disclosed subject matter are listed below (acknowledgement of the references herein is not to be inferred as meaning that these are in any way relevant to the patentability of the presently disclosed subject matter):
GB2575830;
U.S. Pat. No. 9,696,405;
U.S. Pat. No. 9,103,628;
U.S. Pat. No. 8,134,889;
U.S. Pat. No. 7,233,546;
US2013192451;
U.S. Pat. No. 8,320,217;
WO 2006/096208.

### GENERAL DESCRIPTION

In accordance with certain aspects of the presently disclosed subject matter, there is provided a system operative to estimate a location of a projectile launch, the system comprising one or more processing circuitries configured to obtain, from an imaging device, data D_{flash} informative of an optical event associated with the projectile launch, obtain, from acoustic sensors, acoustic data, wherein the acoustic data includes data D_{shockwaves} informative of shock waves generated by a motion of the projectile, and use D_{flash} and D_{shockwaves} to estimate the location of the projectile launch.

In addition to the above features, the device according to this aspect of the presently disclosed subject matter can optionally comprise one or more of features (i) to (xxix) below, in any technically possible combination or permutation:
i. the system is configured to estimate the two-dimensional or the three-dimensional location of the projectile launch;
ii. the system is configured to use D_{shockwaves} to estimate a time t_{shockwaves} at which at least some of the shock waves are sensed by the acoustic sensors, and use t_{shockwaves} to estimate the location of the projectile launch;
iii. the system is configured to use D_{shockwaves} to determine a direction DR_{shockwaves} at which at least some of the shock waves are sensed by the acoustic sensors, and use DR_{shockwaves} to estimate the location of the projectile launch;
iv. the system is configured to obtain a reference acoustic pattern modelling shock waves sensed by the acoustic sensors, and for each given candidate direction of a plurality of candidate directions of the shock waves at which shock waves are sensed by the acoustic sensors, one or more time delays modelling a time difference of sensing of the shock waves between the acoustic sensors, use the reference acoustic pattern, the one or more time delays and D_{shockwaves} to determine the direction DR_{shockwaves};
v. use data D_{flash} to obtain a time t_{flash} which is an estimate of a time t₀ at which the projectile has been launched, and
vi. the system is configured to use the time t_{flash} to estimate the location of the projectile launch;
vii. the system is configured to use data D_{flash} to estimate a direction DR_{flash} at which the projectile has been launched, and use the direction DR_{flash} to estimate the location of the projectile launch;
viii. the system is operative to determine the location of the projectile launch based on D_{flash} and D_{shockwaves} in at least one of (i) or (ii) is met: (i) a scenario in which a blast generated by the projectile launch is sensed by the acoustic sensors with a frequency which is below a detection threshold; (ii) a scenario in which a blast generated by the projectile launch is sensed by the acoustic sensors with a signal to noise ratio which is below a detection threshold;
ix. the detection threshold is equal to 1 kHz;
x. when the blast generated by the projectile launch is sensed by the one or more acoustic sensors with a frequency equal to or below said detection threshold, or with a signal to noise ratio which is below a detection threshold, said blast cannot be identified in the acoustic data provided by the acoustic sensors;
xi. the imaging device includes a plurality of light photodiodes;
xii. the system is configured to use a model to estimate the location of the projectile launch, wherein the model is operative to estimate, for a given location of the projectile launch, a time \hat{t}_{shockwaves} and a direction [symbol] _{shockwaves} at which the shock waves are sensed by the acoustic sensors;
xiii. the system is configured to use a model to estimate, for each of one or more candidate locations of the projectile launch, a time \hat{t}_{shockwaves} and a direction [symbol] _{shockwaves} at which the shock waves are sensed by the acoustic sensors, use D_{shockwaves} to determine a time t_{shockwaves} and a direction DR_{shockwaves} at which at least some of the shock waves are sensed by the acoustic sensors, and use D_{shockwaves}, t_{shockwaves}, [symbol] _{shockwaves} and \hat{t}_{shockwaves} to estimate the location of the projectile launch;
xiv. the system is configured to use a model to estimate, for a plurality of candidate locations of the projectile launch, a time \hat{t}_{shockwaves} and a direction [symbol] _{shockwaves} at which the shock waves are sensed by the acoustic sensors, and use: DR shockwaves, t_{shockwaves}, and [symbol] _{shockwaves} and \hat{t}_{shockwaves} determined for the plurality of candidate locations, to determine a given candidate location of the projectile which meets an optimization criterion;
xv. the model uses a modelled kinematic behavior of the projectile, an estimate \hat{P}_{launch} of the location of the projectile launch. a time t_{flash}, which is an estimate of a time t₀ at which the projectile has been launched, wherein t_{flash} has been determined using data D_{flash} and a direction DR_{flash}, which is an estimate of a direction of the projectile launch, wherein DR_{flash} has been determined using data D_{flash};
xvi. the one or more processing circuitries are configured to implement at least one machine learning model, wherein the one or more processing circuitries are configured to feed the acoustic data, or data informative thereof, to the machine learning model, use the machine learning model to identify, in the acoustic data, data D_{shockwaves} informative of shock waves generated by a motion of the projectile;
xvii. the machine learning model has been trained to detect, for each given type of a plurality of different types of projectiles, in acoustic data, an event corresponding to shock waves generated by a motion of a projectile of said given type;
xviii. the one or more processing circuitries are configured to implement a first machine learning model and a second machine learning model, wherein the first machine learning model has been trained to detect, in acoustic data, an event corresponding to shock waves generated by a motion of a projectile of a first type, and the second machine learning model has been trained to detect, in acoustic data, an event corresponding to shock waves generated by a motion of a projectile of a second type, different from the first type;
xix. the optical event is a muzzle flash associated with the projectile launch;
xx. the projectile is a supersonic projectile;
xxi. the system comprises an electronic card embedding the imaging device, the acoustic sensors, and the one or more processing circuitries;
xxii. the system comprises the imaging device and/or the acoustic sensors;
xxiii. the acoustic data includes data D_{blast} informative of a blast generated by the projectile launch, wherein the system is configured to use D_{flash}, D_{shockwaves} and D_{blast} to estimate the location of the projectile launch, and a firing line direction of the projectile;
xxiv. use D_{flash} and D_{blast} to estimate the location \hat{P}_{launch} of the projectile launch,
xxv. the system is configured to use a model to estimate, for the location \hat{P}_{launch} of the projectile launch and one or more candidate firing line directions of the projectile, a time \hat{t}_{shockwaves} and a direction [symbol] _{shockwaves} at which the shock waves are sensed by the acoustic sensors, use D_{shockwaves} to determine a time t_{shockwaves} and a direction DR shockwaves at which at least some of the shock waves are sensed by the acoustic sensors, use DR_{shockwaves}, t_{shockwaves}, and [symbol] _{shockwaves} and \hat{t}_{shockwaves} determined for the one or more candidate firing line directions of the projectile, to estimate the firing line direction of the projectile;
xxvi. the system is configured to perform a determination of a content of the acoustic data, wherein said determination enables to identify whether the acoustic data includes (i) or (ii): (i) data D_{shockwaves} informative of shock waves generated by a motion of the projectile shock waves, wherein a blast generated by the projectile launch cannot be identified in the acoustic data, (ii) data D_{shockwaves} informative of shock waves generated by a motion of the projectile shock waves and data D_{blast} informative of a blast generated by the projectile launch, and trigger an estimation method of the location of the projectile launch which depends on this determination;
xxvii. the system is operative to be mounted on a moving platform, wherein the system comprises, or is operatively coupled to a sensor operative to provide data Dᵢₙₑᵣₜᵢₐₗ informative of a direction of the moving platform or of the system over time;
xxviii. the system is configured to use D_{flash}, D_{shockwaves} and Dᵢₙₑᵣₜᵢₐₗ to estimate the location of the projectile launch; and
xxix. the system is mounted on at least one of: a military vehicle, a tank, an aircraft.

According to another aspect of the presently disclosed subject matter there is provided a platform comprising the system.

According to another aspect of the presently disclosed subject matter there is provided a method to estimate a location of a projectile launch, the method comprising, by one or more processing circuitries:
obtaining, from an imaging device, data D_{flash} informative of an optical event associated with the projectile launch,
obtaining, from acoustic sensors, acoustic data, wherein the acoustic data includes data D_{shockwaves} informative of shock waves generated by a motion of the projectile, and using D_{flash} and D_{shockwaves} to estimate the location of the projectile launch.

According to some embodiments, the method can include the additional features described above with respect to the system.

According to another aspect of the presently disclosed subject matter there is provided a non-transitory computer readable medium comprising instructions that, when executed by one or more processing circuitries, cause the one or more processing circuitries to perform the operations of the method.

According to another aspect of the presently disclosed subject matter there is provided a system operative to estimate a location of projectile launch, the system comprising one or more processing circuitries configured to:
obtain, from an imaging device, data D_{flash} informative of an optical event associated with the projectile launch,
obtain, from acoustic sensors, acoustic data, wherein the acoustic data includes:
   data D_{shockwaves} informative of shock waves generated by a motion of the projectile, and
   data D_{blast} informative of a blast generated by the projectile launch,
use D_{flash}, D_{shockwaves} and D_{blast} to estimate:
   the location of the projectile launch, and
   a firing line direction of the projectile.

In addition to the above features, the system according to this aspect of the presently disclosed subject matter can optionally comprise one or more of features (xxx) to (xxxii) below (and, in some embodiments, features i to xxix described above):
xxx. the system is configured to use a model which estimates, for a given location of the projectile launch and a given firing line direction of the projectile, a time \hat{t}shockwaves and a direction [symbol] _{shockwaves} at which the shock waves are sensed by the acoustic sensors;
xxxi. the one or more processing circuitries are configured to implement at least one machine learning model, wherein the one or more processing circuitries are configured to feed the acoustic data, or data informative thereof, to the machine learning model and use the machine learning model to identify, in the acoustic data, data D_{shockwaves} informative of shock waves generated by a motion of the projectile and data D_{blast} informative of a blast generated by the projectile launch;
xxxii. the one or more processing circuitries are configured to use D_{flash} and D_{blast} to estimate the location \hat{P}_{launch} of the projectile launch, use a model to estimate, for the location \hat{P}_{launch} of the projectile launch and each of one or more candidate firing line directions of the projectile, a time \hat{t}_{shockwaves} and a direction [symbol] _{shockwaves} at which the shock waves are sensed by the acoustic sensors, use D_{shockwaves} to determine a time t_{shockwaves} and a direction DR_{shockwaves} at which at least some of the shock waves are sensed by the acoustic sensors, use DR_{shockwaves}, t_{shockwaves}, and [symbol] _{shockwaves} and \hat{t}_{shockwaves} determined for the one or more candidate firing line directions of the projectile, to estimate the firing line direction of the projectile.

According to another aspect of the presently disclosed subject matter there is provided a method to estimate a location of projectile launch, the method comprising, by one or more processing circuitries:
obtaining, from an imaging device, data D_{flash} informative of an optical event associated with the projectile launch,
obtaining, from acoustic sensors, acoustic data, wherein the acoustic data includes:
   data D_{shockwaves} informative of shock waves generated by a motion of the projectile, and
   data D_{blast} informative of a blast generated by the projectile launch,
using D_{flash}, D_{shockwaves} and D_{blast} to estimate:
   the location of the projectile launch, and
   a firing line direction of the projectile.

According to some embodiments, the method can include the additional features described above with respect to the system.

According to another aspect of the presently disclosed subject matter there is provided a non-transitory computer readable medium comprising instructions that, when executed by one or more processing circuitries, cause the one or more processing circuitries to perform the operations of the method.

According to another aspect of the presently disclosed subject matter there is provided a system operative to estimate a location of a projectile launch, the system comprising one or more processing circuitries configured to:
obtain, from an imaging device, data D_{flash} informative of an optical event associated with the projectile launch,
obtain, from acoustic sensors, acoustic data, wherein the acoustic data includes data D_{acoustic_impact} informative of a sound generated by an impact of the projectile, and
use data D_{flash} and data D_{acoustic_impact} to estimate the location of the projectile launch.

In addition to the above features, the system according to this aspect of the presently disclosed subject matter can optionally comprise one or more of features (xxxiii) to (xl) below (and, in some embodiments, features i to xxix described above):
xxxiii. the system is configured to use D_{acoustic_impact} to determine a time t_{impact} which is an estimate of a time at which the impact of the projectile has occurred, and use t_{impact} to estimate the location of the projectile launch;
xxxiv. the system is configured to use data D_{flash} to obtain a time t_{flash} which is an estimate of a time t₀ at which the projectile has been launched, and use the time t_{flash} to estimate the location of the projectile launch;
xxxv. the system is configured to use data D_{flash} to estimate a direction DR_{flash} at which the projectile has been launched, and use the direction DR_{flash} to estimate the location of the projectile launch;
xxxvi. the system is configured to use D_{acoustic_impact} to determine a time t_{impact} which is an estimate of a time at which the impact of the projectile has occurred, use data D_{flash} to obtain a time t_{flash} which is an estimate of a time t₀ at which the projectile has been launched, and use t_{impact}, t_{flash} and parameters informative of a kinematic behavior of the projectile to estimate the location of the projectile launch;
xxxvii. the system is operative to determine the location of the projectile launch based on D_{flash} and D_{acoustic_impact} in at least one of (i) or (ii): (i) a scenario in which shock waves generated by a motion of the projectile are not sensed by the acoustic sensors; (ii) a scenario in which the projectile is a subsonic projectile;
xxxviii. the system is operative to be mounted on a moving platform, wherein the system comprises, or is operatively coupled to a sensor operative to provide data Dᵢₙₑᵣₜᵢₐₗ informative of a direction of the moving platform or of the system over time, wherein the system is configured to use Dᵢₙₑᵣₜᵢₐₗ to estimate the location of the projectile launch.
xxxix. the one or more processing circuitries are configured to implement at least one machine learning model, wherein the one or more processing circuitries are configured to feed the acoustic data, or data informative thereof, to the machine learning model, and use the machine learning model to identify, in the acoustic data, data D_{acoustic_impact} informative of a sound generated by an impact of the projectile;
xl. the one or more processing circuitries are configured to implement at least one machine learning model, wherein the one or more processing circuitries are configured to: feed the acoustic data, or data informative thereof, to the machine learning model, use the machine learning model to identify, in the acoustic data, data D_{acoustic_impact} informative of a sound generated by an impact of the projectile at an impact location which is located at a distance from the acoustic sensors which meets a proximity criterion.

According to another aspect of the presently disclosed subject matter there is provided a platform comprising the system.

According to another aspect of the presently disclosed subject matter, there is provided a method to estimate a location of a projectile launch, the method comprising, by one or more processing circuitries:
obtaining, from an imaging device, data D_{flash} informative of an optical event associated with the projectile launch,
obtaining, from acoustic sensors, acoustic data, wherein the acoustic data includes data D_{acoustic_impact} informative of a sound generated by an impact of the projectile, and
using data D_{flash} and data D_{acoustic_impact} to estimate the location of the projectile launch.

According to some embodiments, the method can include the additional features described above with respect to the system.

According to another aspect of the presently disclosed subject matter there is provided a non-transitory computer readable medium comprising instructions that, when executed by one or more processing circuitries, cause the one or more processing circuitries to perform the operations of the method.

According to another aspect of the presently disclosed subject matter there is provided a system operative to estimate a location of a projectile launch, the system comprising one or more processing circuitries configured to:
obtain, from acoustic sensors, acoustic data, wherein the acoustic data includes data D_{acoustic_impact} informative of a sound generated by an impact of the projectile, and data D_{blast} informative of a blast generated by the projectile launch,
use D_{acoustic_impact} and D_{blast} to estimate the location of the projectile launch.

According to some embodiments, the system is configured to use D_{acoustic_impact} to determine a time t_{impact} which is an estimate of a time at which the impact of the projectile has occurred, use D_{blast} to determine a time t_{blast} at which the blast has been sensed by the acoustic sensors, and use t_{impact} and t_{blast} to estimate the location of the projectile launch.

According to another aspect of the presently disclosed subject matter there is provided a method to estimate a location of a projectile launch, the method comprising, by one or more processing circuitries:
obtaining, from acoustic sensors, acoustic data, wherein the acoustic data includes data D_{acoustic_impact} informative of a sound generated by an impact of the projectile, and data D_{blast} informative of a blast generated by the projectile launch,
using D_{acoustic_impact} and D_{blast} to estimate the location of the projectile launch.

According to some embodiments, the method can include the additional features described above with respect to the system.

According to another aspect of the presently disclosed subject matter there is provided a non-transitory computer readable medium comprising instructions that, when executed by one or more processing circuitries, cause the one or more processing circuitries to perform the operations of the method.

According to another aspect of the presently disclosed subject matter there is provided a system operative to estimate a location of projectile launch, the system comprising one or more processing circuitries configured to:
obtain, from an imaging device, data D_{flash} informative of an optical event associated with the projectile launch,
obtain, from acoustic sensors, acoustic data;
perform a determination of a content of the acoustic data, wherein:
   when the determination indicates that the acoustic data includes data D_{shockwaves} informative of shock waves generated by a motion of the projectile, but a blast associated with the projectile launch cannot be identified in the acoustic data, use D_{flash} and D_{shockwaves} to estimate the location of the projectile launch;
   when the determination indicates that the acoustic data includes data D_{acoustic_impact} informative of a sound generated by an impact of the projectile, use data D_{flash} and data D_{acoustic_impact} to estimate the location of the projectile launch;
   when the determination indicates that the acoustic data includes data D_{acoustic_impact} informative of a sound generated by an impact of the projectile and data D_{blast} informative of a blast generated by the projectile launch, use data D_{flash} and data D_{acoustic_impact} to estimate the location of the projectile launch, or data D_{blast} and data D_{acoustic_impact} to estimate the location of the projectile launch.

According to some embodiments, when the determination indicates that the acoustic data D_{shockwaves} informative of shock waves generated by a motion of the projectile the projectile and data D_{blast} informative of a blast generated by the projectile launch, use D_{flash}, D_{shockwaves} and D_{blast} to estimate the location of the projectile launch and a firing line direction of the projectile.

According to another aspect of the presently disclosed subject matter there is provided a method to estimate a location of projectile launch, the method comprising, by one or more processing circuitries:
obtaining, from an imaging device, data D_{flash} informative of an optical event associated with the projectile launch,
obtaining, from acoustic sensors, acoustic data;
performing a determination of a content of the acoustic data, wherein:
   when the determination indicates that the acoustic data includes data D_{shockwaves} informative of shock waves generated by a motion of the projectile, but a blast associated with the projectile launch cannot be identified in the acoustic data, use D_{flash} and D_{shockwaves} to estimate the location of the projectile launch;
   when the determination indicates that the acoustic data includes data D_{acoustic_impact} informative of a sound generated by an impact of the projectile, use data D_{flash} and data D_{acoustic_impact} to estimate the location of the projectile launch;
   when the determination indicates that the acoustic data includes data D_{acoustic_impact} informative of a sound generated by an impact of the projectile and data D_{blast} informative of a blast generated by the projectile launch, use data D_{flash} and data D_{acoustic_impact} to estimate the location of the projectile launch, or data D_{blast} and data D_{acoustic_impact} to estimate the location of the projectile launch.

According to some embodiments, the method can include the additional features described above with respect to the system.

According to another aspect of the presently disclosed subject matter there is provided a non-transitory computer readable medium comprising instructions that, when executed by one or more processing circuitries, cause the one or more processing circuitries to perform the operations of the method.

According to some embodiments, the proposed solution allows determining the location of a projectile launch in adverse conditions (in particular, in conditions which include background noise).

According to some embodiments, the proposed solution allows determining the location of a projectile launch in conditions in which at least some of the prior art systems are inoperative.

According to some embodiments, the proposed solution allows determining the location of a projectile launch at a longer range than at least some of the prior art solutions.

According to some embodiments, the proposed solution provides a system for determining the location of a projectile launch which can be mounted on a heavy and/or a noisy platform (e.g., tank, etc.).

According to some embodiments, the proposed solution provides a system for determining the location of a projectile launch which can be mounted on a moving platform. In particular, according to some embodiments, localization of the projectile launch can be performed while the moving platform is in motion.

According to some embodiments, the proposed solution allows determining the location of a projectile launch even if the shooter uses a silencer.

According to some embodiments, the proposed solution allows determining the location of a projectile launch even in the presence of environmental noise masking the blast associated with the projectile launch.

According to some embodiments, the proposed solution provides a system for determining the location of a projectile launch which is operative even when the projectile hits a target and does not pass the system. In particular, the system is operative for determining the location of a projectile launch even if shock waves generated by the projectile during its motion cannot be detected.

According to some embodiments, the proposed solution provides a system for determining the location of a projectile launch which relies on low-cost and simple components.

According to some embodiments, the proposed solution provides a system for determining the location of a projectile launch which can be mounted on a same electronic circuit/card.

According to some embodiments, the proposed solution allows determining accurately the firing direction of the projectile (in contradiction to prior art methods which could not calculate the firing direction).

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an embodiment of a system which can be used to estimate the location of a projectile launch;

FIG. 2A illustrates a non-limitative example of a launch of a projectile from an offensive system;

FIG. 2B illustrates an embodiment of a method of estimating the location of a projectile launch;

FIG. 2C illustrates a non-limitative example of identification of shock waves within acoustic data by a trained machine learning model;

FIG. 2D illustrates a non-limitative example of a reference pattern of shock waves;

FIG. 2E illustrates an embodiment of a method of training a machine learning model to detect shock waves in acoustic data;

FIG. 2F illustrates schematically the time flow of the events which occur in the method of FIG. 2A;

FIG. 2G illustrates an embodiment of a method of determining the direction at which at least some of the shock waves are sensed by the acoustic sensors;

FIG. 2H illustrates operations which can be performed to estimate the location of the projectile launch in the method of FIG. 2A;

FIG. 2I illustrates a model which can be used to estimate the location of the projectile launch in the method of FIG. 2A;

FIG. 3A illustrates another embodiment of a method of estimating the location of a projectile launch and the firing line direction of the projectile;

FIG. 3B illustrates a non-limitative example of identification of a blast within acoustic data by a trained machine learning model;

FIG. 3C illustrates an embodiment of a method of selecting an estimation process of the location of the projectile launch based on the content of the acoustic data;

FIG. 3D illustrates an embodiment of a method of determining the direction at which the blast generated by the projectile launch is sensed by the acoustic sensors;

FIG. 3E illustrates a particular implementation of operations of the method of FIG. 3A;

FIG. 4A illustrates a non-limitative example of a launch of a projectile from an offensive system, in which the projectile hits a platform on which the system is mounted;

FIG. 4B illustrates a non-limitative example of a launch of a projectile from an offensive system, in which the projectile hits an obstacle located in the vicinity of the platform on which the system is mounted;

FIG. 4C illustrates an embodiment of a method of estimating the location of a projectile launch, which is operative in the context of FIGS. 4A and 4B;

FIG. 4D illustrates an embodiment of a method of selecting an estimation process of the location of the projectile launch based on the content of the acoustic data;

FIG. 4E illustrates a non-limitative example of identification of a projectile hit within acoustic data by a trained machine learning model;

FIG. 4F illustrates an embodiment of a method of training a machine learning model to detect an impact of a projectile in acoustic data;

FIG. 4G illustrates schematically the time flow of the events which occur in the method of FIG. 4C;

FIG. 4H illustrates another embodiment of a method of estimating the location of a projectile launch; and

FIG. 5A illustrates the system for estimating the location of a projectile launch, mounted on a moving platform.

### DETAILED DESCRIPTION

In the following detailed description, numerous specific details are set forth in order to provide a thorough understanding of the invention. However, it will be understood by those skilled in the art that the presently disclosed subject matter can be practiced without these specific details. In other instances, well-known methods have not been described in detail so as not to obscure the presently disclosed subject matter.

Unless specifically stated otherwise, as apparent from the following discussions, it is appreciated that throughout the specification, discussions utilizing terms such as “obtaining”, “using”, “feeding”, “determining”, “estimating”, “training”, “predicting”, “identifying”, or the like, refer to the action(s) and/or process(es) of a computer that manipulate and/or transform data into other data, said data represented as physical, such as electronic, quantities and/or said data representing the physical objects.

Embodiments of the presently disclosed subject matter are not described with reference to any particular programming language. It will be appreciated that a variety of programming languages can be used to implement the teachings of the presently disclosed subject matter as described herein.

The term “launch” of a projectile is known in the art, and includes the launch, projection, ejection, or firing of the projectile.

Non-limitative examples of projectiles include e.g., a bullet, a rocket, a missile, a shell. Depending on the embodiments, the projectile can be a supersonic projectile (ammunition, bullet, etc. —these examples are not limitative), or a subsonic projectile (a rocket, a missile, a shell—these examples are not limitative).

Depending on the embodiments, it would be appreciated that the projectile can be powered or not, and that the projectile can be guided or unguided.

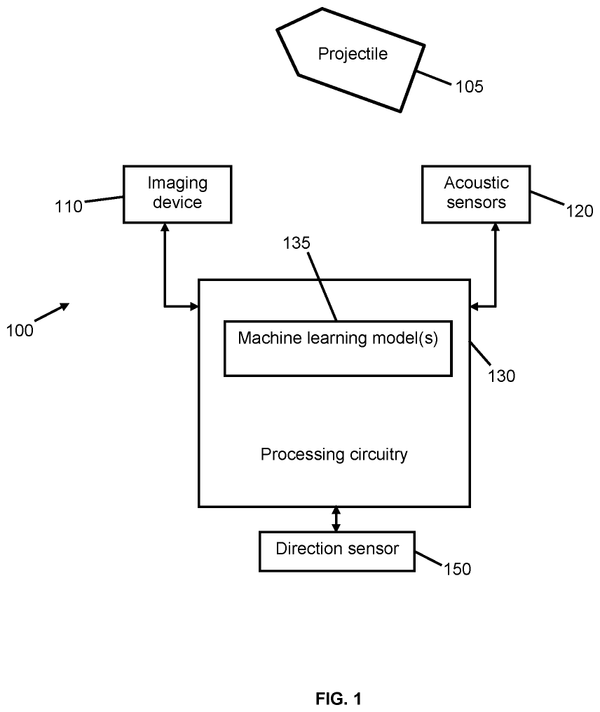

FIG. 1 is a schematic representation of an embodiment of a system 100. As explained hereinafter, system 100 can be used to determine the location of the launch of a projectile 105. The location of the launch of the projectile is the location of the device (launcher—such as a weapon) from which the projectile has been launched.

Elements of the system 100 depicted in FIG. 1 can be made up of any combination of software and hardware and/or firmware. Elements of the system depicted in FIG. 1 may be centralized in one location or dispersed over more than one location. In other examples of the presently disclosed subject matter, the system of FIG. 1 may comprise fewer, more, and/or different elements than those shown in FIG. 1. Likewise, the specific division of the functionality of the disclosed system to specific parts, as described below, is provided by way of example, and other various alternatives are also construed within the scope of the presently disclosed subject matter.

Note that the system 100 can be used also to determine additional (or alternative) data, such as data informative of the path of the projectile, impact point of the projectile, firing line direction of the projectile, etc.

According to some embodiments, at least part or all of the components of the system 100 are mounted on a static platform (static system).

According to some embodiments, at least part or all of the components of the system 100 are mounted on a mobile platform (mobile system). For example, the system 100 can be mounted on a vehicle traveling on land (e.g., a car, a truck, etc.), at sea (e.g., a ship), in the air (e.g., a helicopter, an aircraft, etc.).

The system 100 includes (or is operatively coupled to) an optical subsystem 110 (imaging device 110).

In some embodiments, the imaging device 110 includes light photodiodes. In particular, in some embodiments, it is not required to use a full camera, but rather simple and cheap light photodiodes can be used as the imaging device 110. Light photodiodes indicate, for each pixel, whether intensity of the detected light is above a predefined threshold. Use of light photodiodes is less complex than use of a camera.

In some embodiments, the imaging device 110 can include one or more cameras. The one or more cameras are typically operable in visible and/or infrared wavelength range and are configured for collecting one or more images of a scene.

The imaging device 110 can be operative to detect an optical event associated with a launch of the projectile.

The optical event can include e.g., at least one of a launch flash, a detonation flash, a muzzle flash, an ignition of a propellant, etc. The optical event is approximately coincident with the time of the launch of the projectile (the time difference between sensing of the optical event and the time of the launch is negligible).

According to some embodiments, the imaging device 110 can include (or is operatively coupled to) a processing circuitry, which can include one or more processors and one or more memories, and which is operative to process an optical signal acquired by the imaging device 110, in order to provide data informative of the projectile launch. This processing circuitry can correspond to the processing circuitry 130 described hereinafter, or to a different processing circuitry. The data informative of the projectile launch can include in particular a direction (e.g., angular direction) of the projectile launch. Angular location of the optical event can be determined based on the specific pixels in which the light burst (informative of the optical event associated with the projectile launch) is detected.

Data informative of the projectile launch can further include a time at which the optical event has occurred, which substantially coincides with the time of the projectile launch.

Note that detection of the launch by the imaging device 110 can rely on a known per se imaging device 110. For illustration purposes, non-limiting examples of optical systems that can be used for detecting the launch of the projectile are provided hereinafter:
the imaging device 110 can include a detector that utilizes potassium (K) doublet emission lines (e.g., ~760 nm) or Sodium (N) emission lines detection with contrast to adjacent optical spectrum narrow bands which lack this emission from flash, plume, and fire radiance;
imaging device 110 can include a detector that utilizes the contrast between “Red-band” (within MWIR 4.4 um-4.9 um spectral band) and other MWIR sub-bands as evident in flash, plume, and fire radiance;
the imaging device 110 can include a detector that utilizes solar blind UV (SBUV) emission from flash, plume and/or fire radiance—with contrast to natural and/or artificial scene background which lack significant radiance in the SBUV band;
the imaging device 110 can include a detector module that utilizes LWIR spectral band radiance emitted from flash, plume, and fire radiance;
the imaging device 110 can include a detector that utilizes significant blackbody and/or molecular (e.g., H2O) emission in the SWIR (1.0 um-2.5 um) optical spectral band with contrast to other optical sub-bands (e.g. visible [0.4 um-0.7 um], NIR [0.7 um-1.0 um]) in which the same emission is essentially lower, using one or more sensors dedicated to different spectral sub-bands.

The system 100 includes (or is operatively coupled to) an array of acoustic sensors, including a plurality of acoustic sensors 120. The array of acoustic sensors 120 can include an array of at least two microphones (or more). According to some embodiments, the acoustic sensors 120 are configured to record acoustic signals from the same scene captured by the imaging device 110 (or from a scene which at least partially overlaps with the scene captured by the imaging device 110). According to some embodiments, the acoustic sensors 120 of the array are located at a similar position (each acoustic sensor can be located in the vicinity of the other acoustic sensors of the array).

According to some embodiments, the acoustic sensors 120 can include (or are operatively coupled to) a processing circuitry, operative to process acoustic signal(s) provided by the acoustic sensors 120, as a result of their detection. This processing circuitry can correspond to the processing circuitry 130 described hereinafter, or to a different processing circuitry.

According to some embodiments, system 100 includes a sensor 150 operative to provide data informative of a direction over time (heading) of the system 100 and/or of a platform on which the system 100 is mounted.

The sensor 150 can include for example at least one of: a GPS sensor, one or more accelerometers, a gyroscope, an IMU (Inertial Measurement Unit).

According to some embodiments, the sensor 150 can provide additional data, such as data informative of a position and/or a velocity and/or an acceleration of the system 100 and/or of a platform on which the system 100 is mounted.

The system 100 further includes at least one (or more) processing circuitry 130, comprising one or more processors and one or more memories. The processing circuitry 130 is operatively coupled to the imaging device 110 and/or to the acoustic sensors 120. In particular, it can process signals (optical signals) provided by the imaging device 110 and/or signals (acoustic signals) provided by the acoustic sensors 120.

In some embodiments, the processing circuitry 130 can send commands to the imaging device 110 and/or to the acoustic sensors 120 in order to control operation of the imaging device 110 and/or of the acoustic sensors 120.

In the embodiments in which the sensor 150 is used, the processing circuitry 130 is operative to receive data collected by the sensor 150.

According to some embodiments, the processing circuitry 130 implements a machine learning model 135 (or a plurality of machine learning models), usable to process acoustic data.

In some embodiments, the machine learning model 135 can include a neural network (NN). In some embodiments, the machine learning model 135 can include a deep neural network (DNN).

In particular, the processor can execute several computer-readable instructions implemented on a computer-readable memory comprised in the processing circuitry 130, wherein execution of the computer-readable instructions enables data processing by the machine learning model 135, such as processing of acoustic data, in order to detect shock waves generated by the motion of the projectile.

In some embodiments, the machine learning model 135 is able to detect, in an acoustic signal, a blast (muzzle blast) generated by the launch of the projectile. In some embodiments, the machine learning model 135 is able to detect, in an acoustic signal, both shock waves generated by the motion of the projectile, and the blast generated by the launch of the projectile.

In some embodiments, the machine learning model 135 is able to detect, in an acoustic signal, a sound generated by an impact (hit) of a projectile.

Note that a different machine learning model can be used for detecting the shock waves, the blast, and the impact of the projectile. In some embodiments, the same machine learning model can be trained to detect two of these events (in practice, when there is an impact of the projectile, the shock waves are not sensed by the acoustic sensors), or all of these events.

According to some embodiments, the imaging device 110 and the acoustic sensor(s) 120 are located in close vicinity (e.g., on the same platform).

According to some embodiments, the imaging device 110 and the acoustic sensor(s) 120 are mounted on the same electronic circuit (e.g., PCB).

According to some embodiments, the imaging device 110, the acoustic sensor(s) 120 and also the processing circuitry 130 are mounted on the same electronic circuit (e.g., PCB).

According to some embodiments, the imaging device 110 and the acoustic sensor 120 have a high sampling rate (e.g., of at least 64.000 samples per sec). This is not limitative.

In some embodiments, the imaging device 110 is mounted on a platform, and the acoustic sensors 120 are not mounted on the same platform, but rather in the vicinity of this platform.

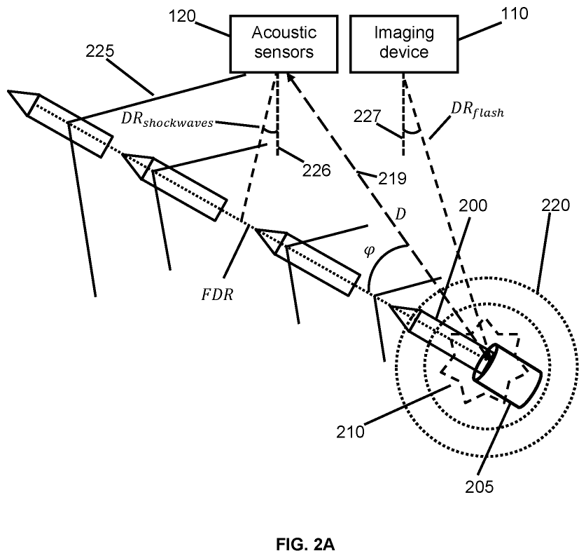

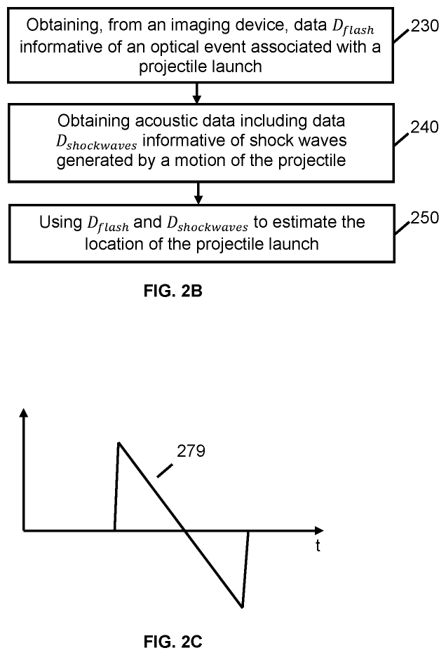

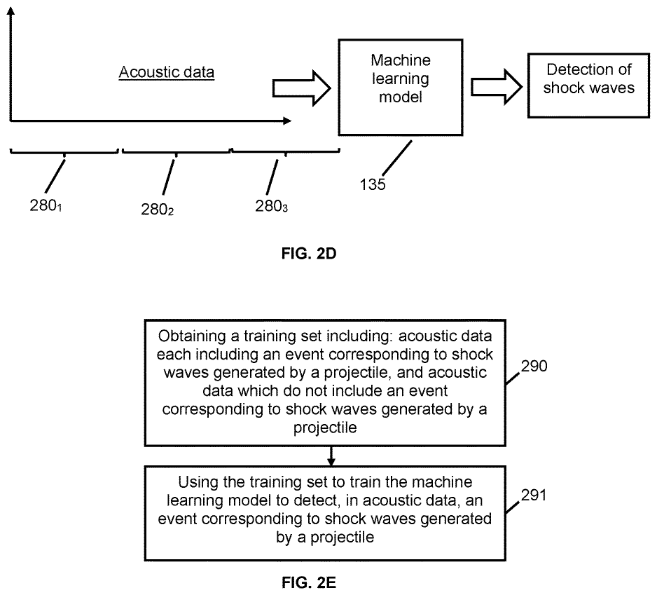

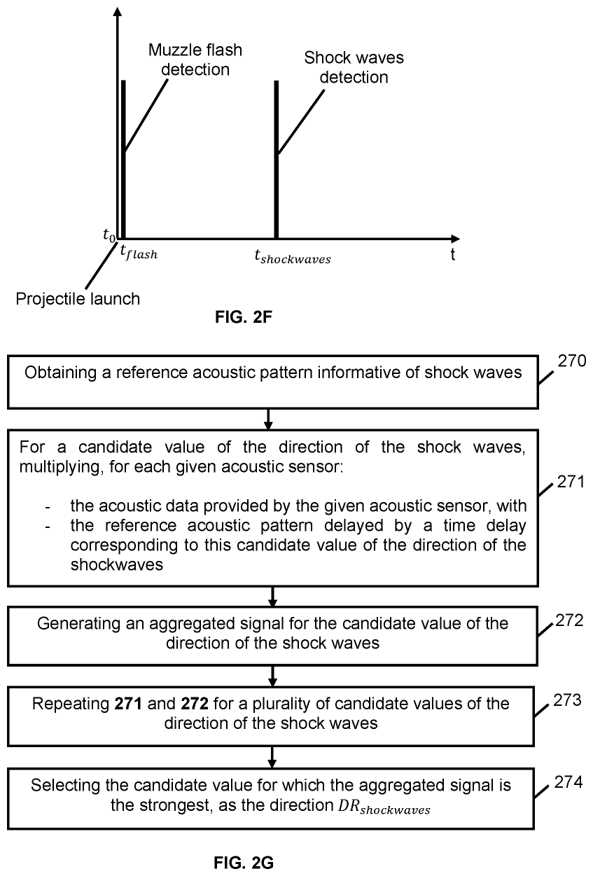

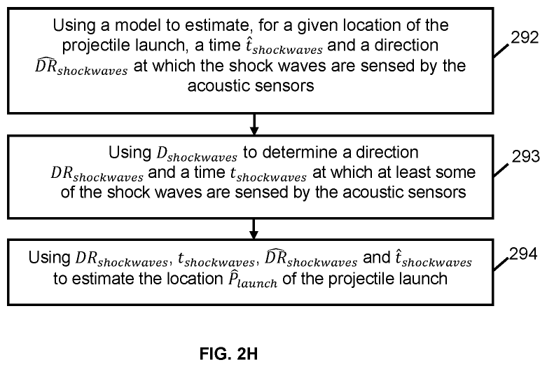

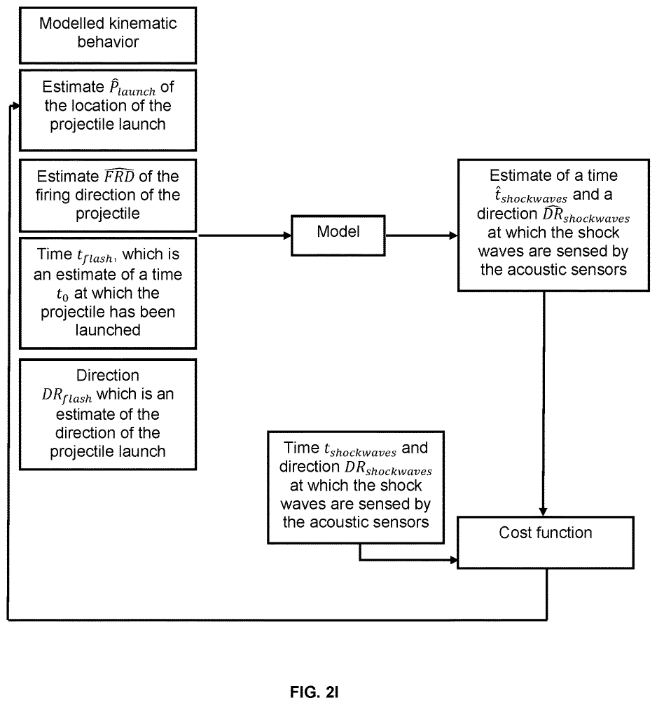

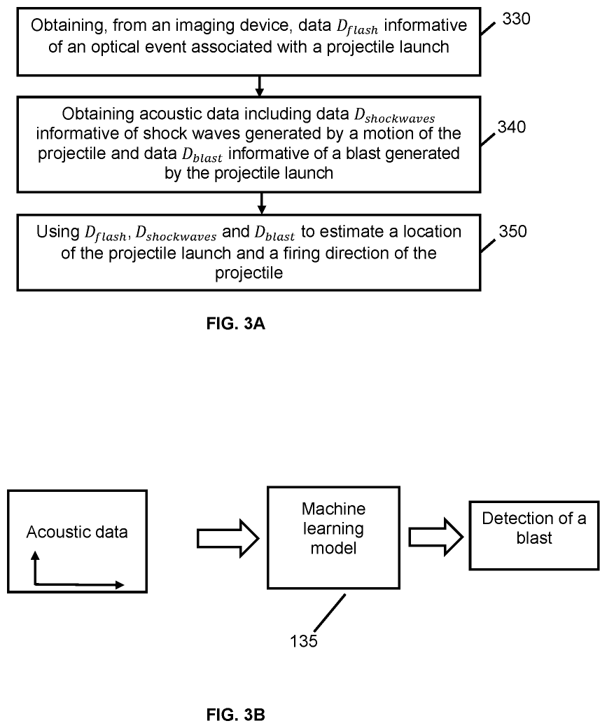

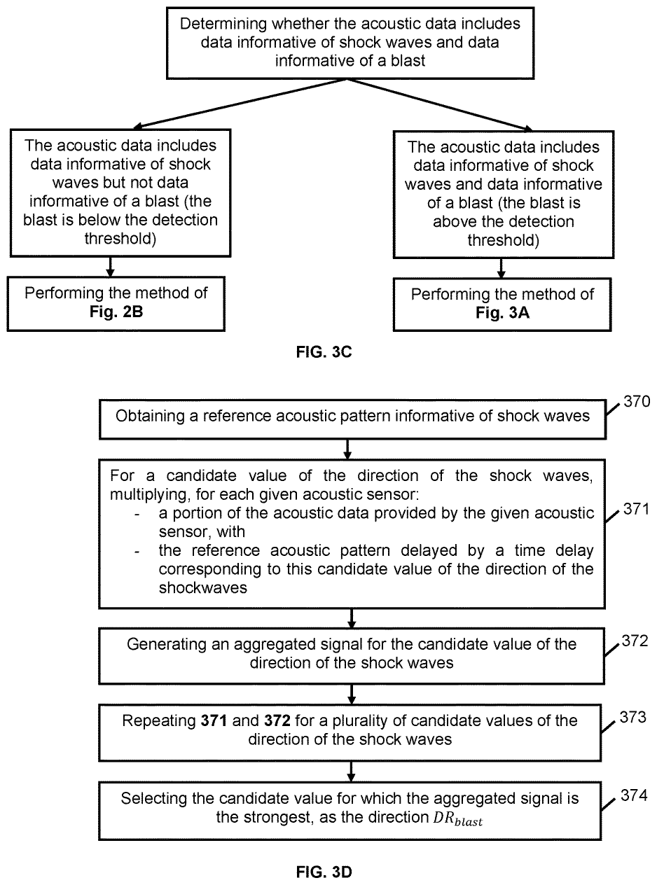

Attention is now drawn to FIGS. 2A and 2B.

FIG. 2A illustrates a launch of a projectile 200 from an offensive system 205 (e.g., a weapon, a launcher, etc.).

The launch of the projectile 200 generates a muzzle flash 210 (optical event). The launch of the projectile 200 can also induce the generation of a blast (launch/detonation blast), which is an acoustic event. The blast includes acoustic waves, schematically represented as (spherical/circular) wavefront 220.

During the flight of the projectile 200, a velocity of the projectile 200 can be higher than the sound velocity in the air (at least during part of its motion, or during all of its motion up to the impact point). In other words, the projectile 200 can be a supersonic projectile.

A supersonic motion of the projectile 200 generates shock waves, which correspond to a type of propagating disturbance that moves faster than the local speed of sound in the air. These shock waves generate a sound in the air. Shock waves are schematically illustrated as reference 225 in FIG. 2A. They propagate along the path of the projectile 200 (also called firing direction or firing line direction).

The direction DR_{shockwaves} is the direction at which at least part of the shock waves is sensed by the acoustic sensors 120. DR_{shockwaves} (or data informative thereof) can be measured as an angle, e.g. with respect to a reference axis 226 of the array of acoustic sensors 120.

In some embodiments, it can occur that the blast cannot be identified in the acoustic data recorded by the acoustic sensors 120.

In particular, according to some embodiments, a blast generated by the projectile launch is sensed by the acoustic sensors 120 with a frequency which is below a detection threshold. According to some embodiments, the detection threshold is equal to 1 kHz. As a consequence, it is not possible to identify the blast in the acoustic data provided by the acoustic sensors 120.

According to some embodiments, a blast generated by the projectile launch is sensed by the acoustic sensors 120 with a signal to noise ratio which is below a detection threshold (in some cases, the blast is not sensed at all by the acoustic sensors 120). As a consequence, it is not possible to identify the blast in the acoustic data provided by the acoustic sensors 120.

This can be caused by various technical factors.

In some embodiments, the distance D between the location of the projectile launch and the acoustic sensors 120 is above a threshold, thereby preventing the acoustic sensors 120 from sensing the blast with a frequency above the detection threshold and/or with a signal to noise ratio above the detection threshold.

In some embodiments, a silencer can be used together with the offensive device 205, thereby reducing the amplitude of the blast generated by the projectile launch.

In some embodiments, the acoustic sensors 120 can be located in an environment in which there is acoustic interference (noise). The noise can be due to elements present in the environment (environmental noise) and/or to the platform on which the acoustic sensor 120 is located. For example, heavy platforms (such as tanks) generate, during their operation, a noise which prevents proper detection of the blast in the acoustic data provided by the acoustic sensors 120.

FIG. 2A also represents the firing line direction FDR (also called barrel angle) of the projectile. The firing line direction corresponds to the direction of the flight path along which the projectile travels (direction along which the projectile has been fired). It can be represented (for example) by the angle φ, which is an angle between the flight path of the projectile and a line 219 joining the location of the projectile launch to the acoustic sensors 120 (or to the system 100). This is not limitative.

Although this is not visible in FIG. 2A, the direction at which the imaging device senses the flash and the direction at which the acoustic sensors sense the blast (when it can be detected) is substantially the same.

Attention is now drawn to FIG. 2B, which describes a method of estimating the location of a projectile launch, in particular in adverse conditions as described with reference to FIG. 2A.

Note that the method of FIG. 2B can use the system 100 as described with reference to FIG. 1.

Assume that a projectile is launched from a certain location. For example, a sniper shoots a bullet using a rifle.

The method includes obtaining (operation 230) data D_{flash} informative of an optical event associated with the projectile launch. In particular, data D_{flash} is obtained by the processing circuitry 130 from the imaging device 110. Note that D_{flash} can correspond to the output of the imaging device 110, or to a signal derived from the output of the imaging device 110 (for example, the output of the imaging device 110 can undergo some intermediate processing (e.g., removal of noise, etc.)) before it is sent to the processing circuitry 130.

As mentioned above, when the projectile is launched, a muzzle flash (optical event) is generated, which is detected by the imaging device 110. A signal informative of the muzzle flash detected by the imaging device 110 (or a signal derived thereof) can be obtained by the processing circuitry 130 from the imaging device 110. The signal can include e.g., a distribution of pixel intensities and/or a sequence of images acquired by the imaging device 110.

Assume that the projectile is launched at time t₀. The muzzle flash is detected at time t_{flash}=t₀+ϵ by the imaging device 110. Since the speed of light is large relative to the distance between the imaging device 110 and the location of the projectile launch, it can be assumed that the time at which the muzzle flash is detected by the imaging device 110 corresponds to time t₀ (t_{flash}≈t₀).

Note that data D_{flash} can be used to determine the direction DR_{flash} at which the projectile has been launched. This direction can be expressed e.g., with respect to a reference axis 227 (line of sight) of the imaging device 110 (see FIG. 2A). This is not limitative. Embodiments for determining the direction of the muzzle flash have been provided above and are known per se. The location of the projectile launch should therefore be on the direction DR_{flash}, at a certain range to be determined.

As explained above, when the projectile is flying at a velocity which is greater than the speed of sound in the air, shock waves are generated along the path of the projectile.

The method further includes obtaining (operation 240) acoustic data from the array of acoustic sensors 120. Assume a scenario in which the motion of the projectile generates shock waves, which are sensed by the acoustic sensors 120. When the projectile passes the acoustic sensors 120, the shock waves propagate towards the acoustic sensors 120 and therefore can be sensed by the acoustic sensors 120. This is visible in the non-limitative example of FIG. 2A, in which the shock waves 225 are sensed by the acoustic sensors 120 when the projectile 200 passes the acoustic sensors 120.

Therefore, the acoustic data provided by the acoustic sensors 120 include data D_{shockwaves} informative of shock waves generated by a motion of the projectile. Methods for identifying shock waves within the acoustic data will be provided hereinafter.

Assume that the method of FIG. 2B is executed in a scenario in which a blast generated by the projectile launch is sensed by the acoustic sensors 120 with a frequency below a detection threshold (and/or with a signal to noise ratio below a detection threshold).

As a consequence, the blast cannot be identified in the acoustic data provided by the acoustic sensors 120. Thus, the blast cannot be used to determine a direction and/or a location of the projectile launch using the methods described in the prior art.

Operation 240 can include identifying the shock waves in the acoustic data.

In some embodiments, a database stores a plurality of acoustic patterns which are characteristics of shock waves generated by projectiles of interest (e.g., bullets, etc.). Note that a typical pattern (time signal) of shock waves (this example is not limitative) is visible in reference 279 of FIG. 2C.

The processing circuitry 130 performs a comparison between these patterns and the acoustic data provided by the acoustic sensors 120 in order to identify the shock waves in the acoustic data. In some embodiments, the database stores the type of projectile associated with each acoustic pattern. Therefore, this comparison can be used to identify the type of the projectile.

In some embodiments, a machine learning model (see reference 135 in FIG. 1) can be used to identify the shock waves. This is illustrated in the non-limitative example of FIG. 2D.

The acoustic data, or data informative thereof, is fed to the machine learning model 135.

The machine learning model 135 has been trained to detect, in an acoustic signal, presence of shock waves within the acoustic signal. The machine learning model 135 is therefore used to identify, in the acoustic data, an event corresponding to shock waves sensed by the acoustic sensors 120. The machine learning model 135 can therefore output data D_{shockwaves} informative of shock waves generated by a motion of the projectile. In some embodiments, data D_{shockwaves} includes the portion of the acoustic data (acoustic signal over time) corresponding to the sensing of the shock waves by the acoustic sensors 120. In some embodiments, data D_{shockwaves} can include the time t_{shockwaves} at which the acoustic sensors 120 have sensed the shock waves.

Note that the acoustic data D_{shockwaves} sensed by the acoustic sensors 120 over time can be fed in real time or quasi real time to the machine learning model 135. For each piece of data 2801, 2802, 2803 (etc.) of the acoustic data (each piece of data corresponds to a fraction of the acoustic data over a predefined period of time), the machine learning model 135 can output a prospect (a probability) that this piece of data includes an acoustic event corresponding to shock waves generated by the supersonic motion of a projectile. When this probability is above a threshold, this indicates that the acoustic event can be considered as shock waves generated by the supersonic motion of a projectile.

FIG. 2E describes a method of training the machine learning model 135 to detect shock waves in acoustic data. The method can be performed by a processing circuitry (such as processing circuitry 130). The method includes obtaining (operation 290) a training set comprising a plurality of acoustic data.

Some of the acoustic data includes an acoustic event corresponding to shock waves generated by the supersonic motion of a projectile (“positive samples”).

Some of the acoustic data do not include an acoustic event corresponding to shock waves generated by the supersonic motion of a projectile (“negative samples”).

In some embodiments, the training includes supervised or semi-supervised learning. Each acoustic data is associated with a label, indicative of whether it includes an acoustic event corresponding to shock waves generated by the supersonic motion of a projectile (the label can also include the time at which the shock waves are present in the acoustic data). The label can be provided e.g., by an operator. This is not limitative, and the training can also include automatic training and/or non-supervised learning.

The training set is then used (operation 291) to train the machine learning model 135 to identify, based on an input including acoustic data, an acoustic event corresponding to shock waves generated by the supersonic motion of a projectile.

The training can rely on techniques such as Backpropagation. This is however not limitative.

According to some embodiments, the training set includes acoustic events corresponding to shock waves generated by the supersonic motion of different types of projectiles (e.g., different calibers, different weights, different shapes, etc.).

According to some embodiments, the machine learning model 135 is trained to detect the shock waves in the acoustic data, and to determine the type of projectile. In this embodiment, the training set includes:
acoustic data including events corresponding to shock waves generated by the supersonic motion of different types of projectiles, wherein a label indicates presence of the shock waves (and time location in the acoustic data) and the type of projectile which generated these shock waves (the label can be provided by an operator who annotates the data);
acoustic data which do not include acoustic events corresponding to shock waves generated by the supersonic motion of a projectile. A label indicates that these acoustic data do not include any shock waves generated by the supersonic motion of a projectile.

The training set is then used to train the machine learning model 135 to both identify the shock waves, and to determine the type of projectile which generated these shock waves.

According to some embodiments, a plurality of machine learning models is used. Each machine learning model is trained to detect an acoustic event corresponding to shock waves generated by the supersonic motion of a different type of projectile. For example, the first machine learning model is trained to detect an acoustic event corresponding to shock waves generated by the supersonic motion of a bullet of a first caliber, the second machine learning model is trained to detect an acoustic event corresponding to shock waves generated by the supersonic motion of a bullet of a second caliber (different from the first caliber), etc.

In a prediction mode (see operation 240 in which the shock waves are identified in the acoustic data), this set of machine learning models can be used as explained hereinafter.

If the type of projectile is known in advance, then the corresponding machine learning model (which has been specifically trained for this type of projectile) can be used at operation 240 to identify the shock waves. The acoustic data are fed to the machine learning model trained for this type of projectile.

If the type of projectile for which the launch is not known in advance, then the acoustic data can be fed to each of the plurality of machine learning models. The output of the different machine learning models can be aggregated (using various methods such as averaging, voting method, etc.) to generate a decision of whether shock waves are present. The type of projectile can also be identified using this method.

Reverting to the method of FIG. 2B, once an event corresponding to shock waves has been identified in the acoustic data, a corresponding time t_{shockwaves} (at which at least some of the shock waves are sensed by the acoustic sensors 120) can be registered.

FIG. 2F illustrate schematically the time flow of the events which occur in the method of FIG. 2A. As visible in FIG. 2F, the optical event (muzzle flash) is sensed by the imaging device 110 at time t_{flash}, immediately after launch of the projectile at time t₀. After a time delay, the shock waves are detected by the acoustic sensors 120 at time t_{shockwaves}.

Note that D_{shockwaves} can be used also to determine the direction DR_{shockwaves} (see FIG. 2A) at which at least some of the shock waves are sensed by the acoustic sensors 120, as explained with reference to the method of FIG. 2G.

The method of FIG. 2G can include obtaining (operation 270) a reference acoustic pattern (time signal) informative of shock waves. Note that the method of FIG. 2G is provided as an example and other methods can be used.

Depending on the direction at which the acoustic sensors 120 sense the shock waves, the acoustic sensors 120 sense the shock waves with a different delay between them. For example, for a direction of the shock waves corresponding to an angle of β₁ degrees, the delay between the first acoustic sensor and the second sensor is equal to Δt₁, for a direction of the shock waves corresponding to an angle of β₂ degrees, the delay between the first acoustic sensor and the second sensor is equal to Δt₂, etc. Note that if more than two acoustic sensors are used (e.g., sensors S₁ to S_{N}, with N>2), a corresponding delay can be stored between the sensors (delay Δt₁ between sensor S₁ and sensor S₂, delay Δt₂ between sensor S₂ and sensor S₃, etc). The different time delays for the different candidate direction of the shock waves can be determined in advance and stored in a database.

The method further includes, for a candidate value of the direction DR_{shockwaves}, multiplying (operation 271), for each given acoustic sensor of the array:
a portion of the acoustic data provided by the given acoustic sensor (in particular, the portion D_{shockwaves} of the acoustic data corresponding to the shock waves), with
the reference acoustic pattern delayed by the time delay corresponding to this candidate value of the direction DR_{shockwaves}.

A signal is therefore obtained for each acoustic sensor. An aggregated signal can be obtained by summing the different signals obtained for the different acoustic sensors of the array (operation 272).

This process can be repeated for a plurality of different candidate values of the direction DR_{shockwaves} (operation 273). The candidate value for which the aggregated signal is the strongest can be selected as the estimate of the direction DR_{shockwaves} (operation 274).

The method of FIG. 2B further includes using (operation 250) D_{flash} and D_{shockwaves} to estimate the location of the projectile launch. The two-dimensional or the three-dimensional location of the projectile launch is estimated.

Note that the method of FIG. 2B can be performed with a system 100 mounted on a moving platform.

Operation 250 can involve using:
time t_{flash}, which is an estimate of the time t₀ of the projectile launch (which can be determined using D_{flash});
the direction DR_{flash}, which is an estimate of the direction of the projectile launch (which can be determined using D_{flash});
a modelled kinematic behavior of the projectile. The modelled kinematic behavior takes into account various parameters which enable describing the flight of the projectile, such as drag, mass of the projectile, muzzle velocity, etc. Note that for parameters which are unknown, estimated values can be used, which can be updated using an iterative optimization process; and
D_{shockwaves} (from which it can be determined a time t_{shockwaves} and a direction DR_{shockwaves} at which at least some of the shock waves are sensed by the acoustic sensors 120).

According to some embodiments, operation 250 comprises using a model operative to estimate, for a given location of the projectile launch, a time \hat{t}_{shockwaves} and a direction [symbol] _{shockwaves} at which the shock waves are sensed by the acoustic sensors.

In particular, operation 250 can include (see FIG. 2G) using (operation 292) the model to estimate, for each of one or more candidate locations of the projectile launch (which can be initialized with a guess value), a time \hat{t}_{shockwaves} and a direction [symbol] _{shockwaves} at which the shock waves are sensed by the acoustic sensors. The model can rely on a physical model of shock waves propagation: since all parameters of the flight of the projectile are known or estimated, the model can predict the time and direction at which the shock waves will be sensed by the acoustic sensors.

The method can include (operation 293) using D_{shockwaves} to determine:
a direction DR_{shockwaves} at which at least some of the shock waves are sensed by the acoustic sensors 120 (see a corresponding method in FIG. 2F);
a time t_{shockwaves} at which at least some of the shock waves are sensed by the acoustic sensors 120.

The method can further include using (operation 294) DR shockwaves, t_{shockwaves}, [symbol] _{shockwaves} and \hat{t}_{shockwaves} to estimate the location \hat{P}_{launch} of the projectile launch. In particular, an iterative process of optimization can be used, as explained hereinafter.

In some embodiments of this iterative process, [symbol] _{shockwaves} and t_{shockwaves} are determined for a plurality of candidate locations of the projectile launch using the model, and DR_{shockwaves}, t_{shockwaves}, [symbol] _{shockwaves} and \hat{t}_{shockwaves} are used to determine a given candidate location of the projectile which meets an optimization criterion.

FIG. 2H illustrates a particular method of implementing operation 250, in order to estimate the location of the projectile launch. Note that this method is only an example and is not limitative.

The method includes obtaining:
a modelled kinematic behavior of the projectile;
an estimate \hat{P}_{launch} of the location of the projectile launch;
an estimate [symbol] of a firing line direction of the projectile;
a time t_{flash}, which is an (accurate) estimate of a time t₀ at which the projectile has been launched (t_{flash} is determined using data D_{flash});
a direction DR_{flash}, which is an estimate of the direction of the projectile launch (DR_{flash} is determined using data D_{flash}).

\hat{P}_{launch} is initially unknown and can be initialized with a guess or a random value. Similarly, [symbol] is unknown and can be estimated with a guess or a random value. In some embodiments, the firing direction (see angle φ) can be (initially) considered as small and can be neglected.

The model estimates, for a given location (\hat{P}_{launch}) of the projectile launch, a time \hat{t}_{shockwaves} and a direction [symbol] _{shockwaves} at which the shock waves are sensed by the acoustic sensors.

The method can include using a cost function which is informative of:
a difference between \hat{t}_{shockwaves} and t_{shockwaves}, and
a difference between [symbol] _{shockwaves} and DR_{shockwaves}.

The method can include attempting to minimize the cost function for different candidate values of \hat{P}_{launch} located along the direction DR_{flash}.

The value of \hat{P}_{launch} which minimizes the cost function can be used as the estimate of the location of the projectile launch.

The method can include using D_{shockwaves} to determine a time t_{shockwaves} and a direction DR_{shockwaves} at which at least some of the shock waves are sensed by the acoustic sensors.

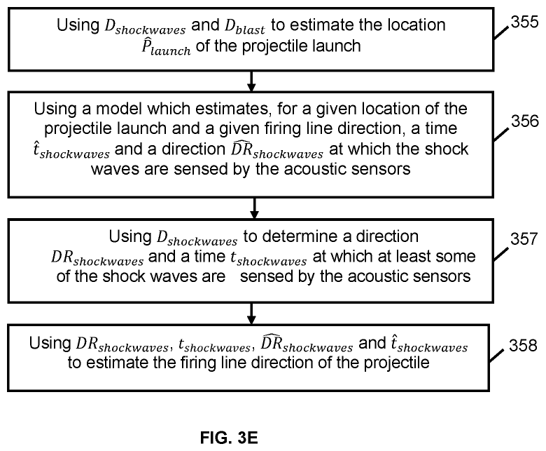

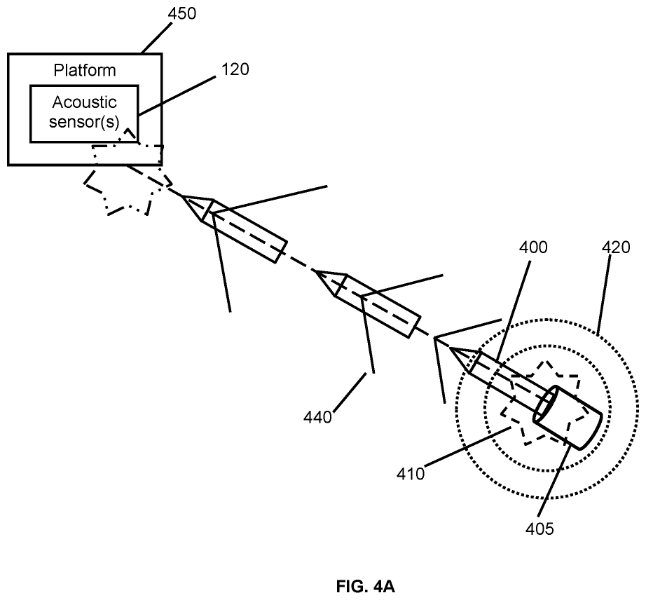

Attention is now drawn to FIG. 3A.

In the embodiment of FIG. 3A, the acoustic data provided by the acoustic sensors include not only data D_{shockwaves} informative of shock waves generated by a motion of the projectile, but also data D_{blast} informative of the blast generated by the projectile launch.

In other words, in this embodiment, the blast generated by the projectile launch is sensed by the acoustic sensors 120 with a frequency above the detection threshold (and with a signal to noise ratio above the detection threshold).

The method of FIG. 3A includes obtaining (operation 330) data D_{flash} informative of an optical event associated with the projectile launch. In particular, data D_{flash} is obtained by the processing circuitry 130 from the imaging device 110. Operation 330 is similar to operation 230 and is therefore not detailed again.

The method of FIG. 3A further includes (operation 340) obtaining acoustic data from the acoustic sensors 120.

As mentioned above, in this embodiment, the acoustic data includes both data D_{shockwaves} informative of shock waves generated by a motion of the projectile and data D_{blast} informative of a blast generated by the projectile launch.

Methods for identifying shock waves within the acoustic data have been provided hereinafter.

A method for identifying a blast within the acoustic data is provided hereinafter with respect to FIG. 3B.

In some embodiments, a database stores a plurality of acoustic patterns which are characteristics of a blast generated by projectiles of interest (e.g., bullets, etc.). The processing circuitry 130 performs a comparison between these patterns and the acoustic data provided by the acoustic sensors 120 in order to identify the blast in the acoustic data.

In some embodiments, a trained machine learning model (see reference 135 in FIG. 1) can be used to identify the blast. This is illustrated in the non-limitative example of FIG. 3B.

Training of the machine learning model to detect a blast is similar to training of the machine learning to detect shock waves. A training set comprising a plurality of acoustic data is used, in which some of the acoustic data includes an acoustic event corresponding to a blast generated by a projectile launch (“positive samples”), and some of the acoustic data do not include an acoustic event corresponding to a blast generated by a projectile launch (“negative samples”). Each acoustic data is associated with a label, indicative of whether it includes an acoustic event corresponding to a blast generated by the projectile launch. The label can also include the time location of the blast in the acoustic data.

The training set is then used to train the machine learning model 135 to identify, based on an input including acoustic data, an acoustic event corresponding to a blast generated by the projectile launch.

Note that, as visible in FIG. 3C, it is not always known in advance which data will be present in the acoustic data provided by the acoustic sensors. The system can therefore rely, for example, on the smart process of FIG. 3C. The method of FIG. 3C first identifies which data is present in the acoustic data. If the acoustic data includes data informative of shock waves, but does not include data informative of a blast (the blast is below the detection threshold), then the processing circuitry 130 instructs to perform the method of FIG. 2B. If the acoustic data includes both data informative of shock waves and data informative of a blast, the processing circuitry 130 instructs to perform the method of FIG. 3A. Note that in some cases, the shock waves cannot be detected, and other method(s) can be performed. This will be described hereinafter.

Data D_{blast} can be used to determine the time at which the blast has been sensed by the acoustic sensors 120. This time is noted t_{blast}.

In some embodiments, once the blast has been identified, the direction DR_{blast} of the blast can be determined (see FIG. 3D). Direction DR_{blast} can correspond to an angular direction between a reference line of the acoustic sensors 120 and the estimate origin of the blast (which is the location of the projectile launch).

The method of FIG. 3D can include obtaining (operation 370) a reference acoustic pattern (time signal) informative of a blast. Note that the method of FIG. 3D is provided as an example and other methods can be used.

Depending on the direction at which the acoustic sensors 120 sense the blast, the acoustic sensors 120 sense the blast with a different delay between them. For example, for a direction of the blast corresponding to an angle of γ₁ degrees, the delay between the first acoustic sensor and the second sensor is equal to Δt₁, for a direction of the blast corresponding to an angle of γ₂ degrees, the delay between the first acoustic sensor and the second sensor is equal to Δt₂, etc. Note that if more than two acoustic sensors are used (e.g., sensors S₁ to S_{N}, with N>2), a corresponding delay can be stored between the sensors (delay Δt₁ between sensor S₁ and sensor S₂, delay Δt₂ between sensor S₂ and sensor S₃, etc). The different time delays for the different candidate direction of the blast can be determined in advance and stored in a database.

The method further includes, for a candidate value of the direction DR_{blast}, multiplying (operation 371), for each given acoustic sensor of the array:
a portion of the acoustic data provided by the given acoustic sensor (in particular, the portion D_{blast} of the acoustic data corresponding to the blast), with
the reference acoustic pattern delayed by the time delay corresponding to this candidate value of the direction DR_{blast}.

A signal is therefore obtained for each acoustic sensor, which can be converted into the frequency domain (using e.g., IFFT). An aggregated signal can be obtained by summing the different signals obtained for the different acoustic sensors of the array (operation 372).

This process can be repeated for a plurality of different candidate values of the direction DR_{blast} (operation 373). The candidate value for which the aggregated signal is the strongest can be selected as the estimate of the direction DR_{blast} (operation 374).

Reverting to the method of FIG. 3A, the method further includes using (operation 350) D_{flash}, D_{shockwaves} and D_{blast} to estimate a location of the projectile launch and a firing direction of the projectile. In particular, t_{flash}, DR_{flash} (and/or DR_{blast}), t_{blast}, DR_{shockwaves} and t_{shockwaves} can be used to estimate a location of the projectile launch and a firing direction of the projectile.

In some embodiments, DR_{blast} can be also used. For example, in some embodiment, DR_{blast} can be used instead of DR_{flash} to estimate the direction of the projectile launch. In some embodiments, when a plurality of projectiles is launched, a correlation between DR_{blast} and DR_{flash} can be performed to validate that the blast and the flash originates from the same projectile launch.

Note that the method of FIG. 3A can be performed with a system 100 mounted on a moving platform.

FIG. 3E illustrates an embodiment of operation 350.

It includes using (operation 355) using D_{flash} and D_{blast} to estimate the location \hat{P}_{launch} of the projectile launch. Since the direction of the projectile launch is known from DR_{flash} (or DR_{blast}), it remains to determine the range R to the projectile launch. In some embodiments, the following formula can be used:

R=(t_{blast}−t_{flash})c_{sound}

In this equation, c_{sound} is the speed of sound in the air.

Note that in some embodiments, the location of the projectile launch can be determined using D_{flash} and D_{shockwaves} (using e.g., the method described in WO 2006/096208), or using D_{blast} and D_{shockwaves}.

The method can further include (operation 356) using a model (see the model mentioned above) which estimates, for an estimate \hat{P}_{launch} of the location of the projectile launch and a given firing line direction of the projectile, a time \hat{t}_{shockwaves} and a direction [symbol] _{shockwaves} at which the shock waves are sensed by the plurality of acoustic sensors. Note that at the beginning of the process, the firing line direction is unknown and can be initialized with a guess value.

The method can further include using (operation 357) D_{shockwaves} to determine a time t_{shockwaves} and a direction DR_{shockwaves} at which at least some of the shock waves are sensed by the acoustic sensors.

The method can further include using (operation 358) DR_{shockwaves}, t_{shockwaves}, [symbol] _{shock} waves and \hat{t}_{shockwaves} to estimate the firing line direction of the projectile.

In some embodiments, a plurality of candidate firing line directions are tested, and the candidate firing line direction which meets an optimization criterion is selected as the estimate.

In particular, in some embodiments, the method can include using a cost function which is informative of:
a difference between \hat{t}_{shockwaves} and t_{shockwaves}, and
a difference between [symbol] _{shockwaves} and DR_{shockwaves}.

The method can include attempting to minimize the cost function for different candidate values of the firing line direction FDR.

The value of FDR which minimizes the cost function (optimization criterion) can be used as the estimate of the firing line direction.

Note that this method is however not limitative.

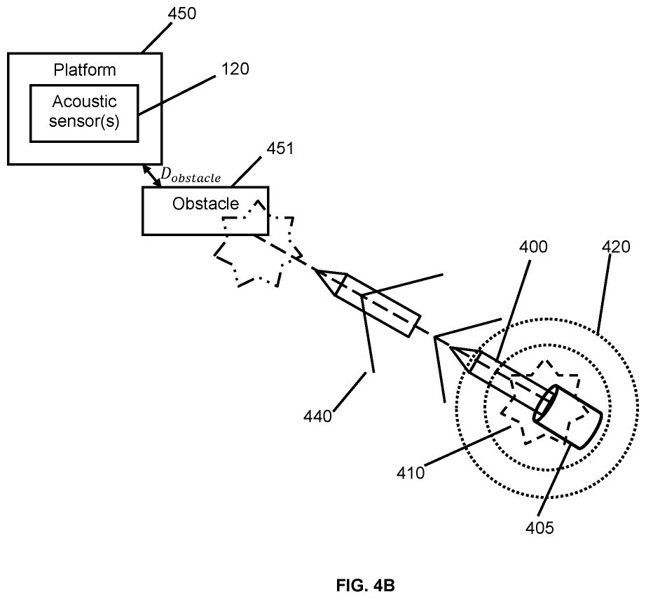

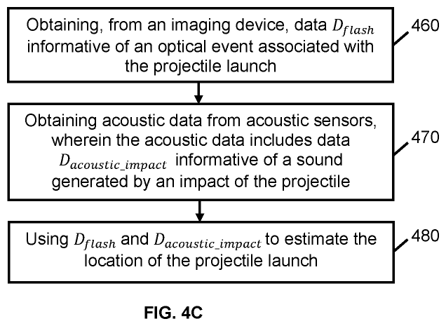

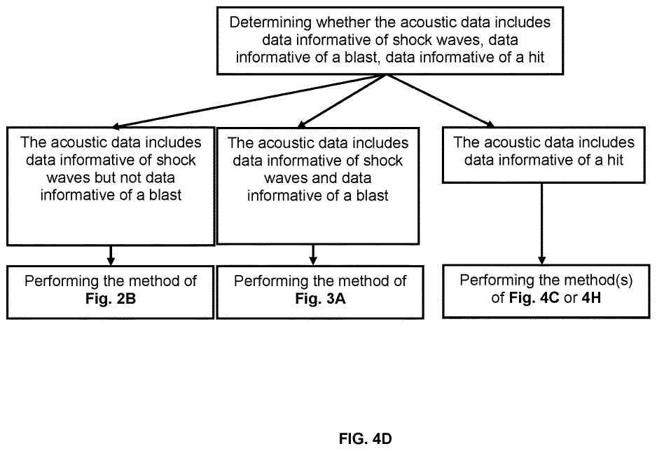

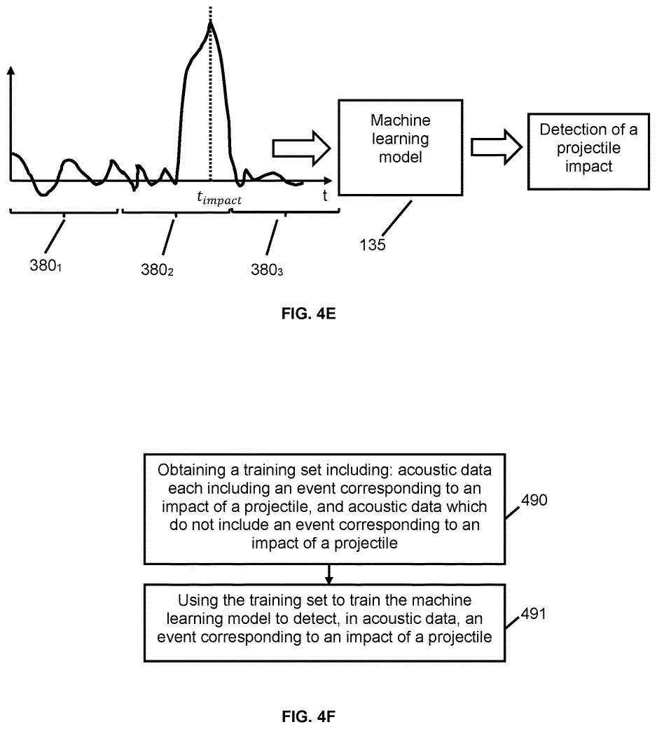

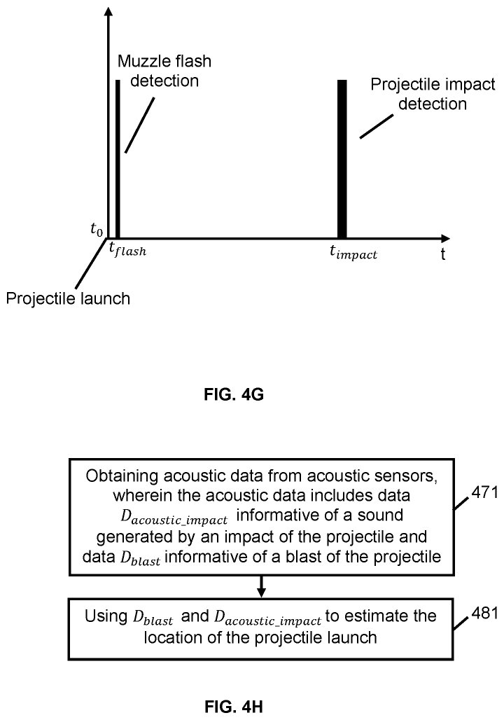

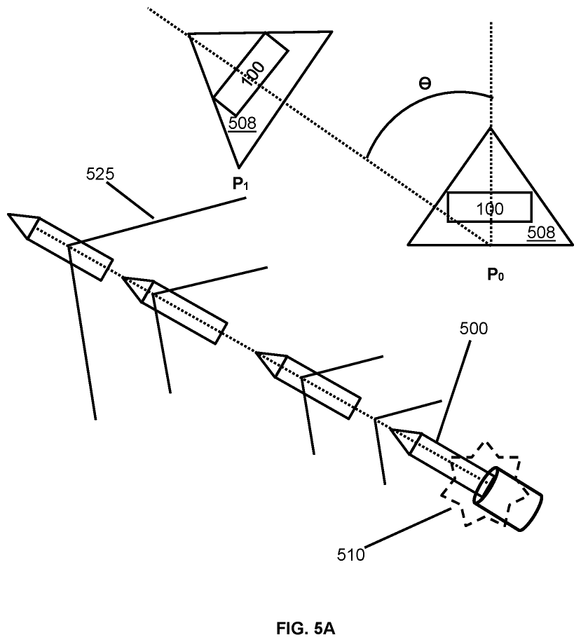

Attention is now drawn to FIG. 4A, which illustrates a launch of a projectile 400 from an offensive system 405 (e.g., a weapon).

The launch of the projectile 400 induces a muzzle flash 410 (optical event). The launch of the projectile 400 can also induce the generation of a blast (launch/detonation blast), which is an acoustic event. The blast includes acoustic waves, schematically represented as (spherical/circular) wavefront 420.

During the flight of the projectile 400, a velocity of the projectile 400 can be higher than the sound velocity in the air (at least during part of its motion, or all of its motion up to the impact point). In other words, the projectile 400 can be a supersonic projectile.

A supersonic motion of the projectile 400 generates shock waves, which correspond to a type of propagating disturbance that moves faster than the local speed of sound in the air. These shock waves generate a sound in the air. Shock waves are schematically illustrated as reference 440 in FIG. 4A.

In the configuration of FIG. 4A, the projectile impacts a platform 450 (for example a vehicle) on which the acoustic sensors 120 are mounted. As a consequence, the acoustic sensors 120 do not sense the sound generated by the shock waves 440.

This is due to the fact that if the projectile 400 does not pass the acoustic sensors 120, the shock waves cannot be sensed by the acoustic sensors 120. A similar phenomenon is visible in the stern waves generated by a ship.

Similarly, as shown in FIG. 4B, if the projectile 400 impacts an obstacle 451 (e.g., the ground or another target) located in front or in the vicinity of the acoustic sensors 120 (thereby preventing the projectile 400 from passing the acoustic sensors 120), then the shock waves generated by the projectile 400 cannot be sensed by the acoustic sensors 120.

FIG. 4C describes a method of determining the location of projectile launch, even if the shock waves generated by the motion of the projectile are not sensed by the acoustic sensors 120. This can occur either because: (i) the projectile is a supersonic projectile which generates shock waves during its motion, but which are not detected due to the impact of the projectile before it passes in front of the acoustic sensors, or (ii) the projectile is a subsonic projectile, which therefore does not generate shock waves.

In either case, the acoustic sensors 120 do not sense any shock waves generated by the motion of a projectile of interest.

The method of FIG. 4C includes obtaining (operation 460), from an imaging device, data D_{flash} informative of an optical event associated with the projectile launch. Operation 460 is similar to operation 430 and is therefore not described again.

The method further includes obtaining (operation 470) acoustic data from one or more acoustic sensors 120, wherein the data includes data D_{acoustic_impact} informative of a sound generated by an impact of the projectile.

For example, as mentioned above, the projectile may have impacted the platform on which the acoustic sensor 120 is located, or an obstacle located in the vicinity of the acoustic sensor 120 (thereby preventing the projectile from passing the acoustic sensors 120).

Operation 470 can include identifying, in the acoustic data, data D_{acoustic_impact} informative of an event corresponding to an impact (hit) of the projectile.

Note that, as visible in FIG. 4D, it is not always known in advance which data will be present in the acoustic data provided by the acoustic sensors. The system can therefore rely for example on the smart process of FIG. 4D. The method of FIG. 4D first identifies which data is present in the acoustic data. If the acoustic data includes data informative of shock waves, but does not include data informative of a blast (the blast is below the detection threshold), then the processing circuitry 130 instructs to perform the method of FIG. 2B. If the acoustic data includes both data informative of shock waves and data informative of a blast, the processing circuitry 130 instructs to perform the method of FIG. 3A. If the acoustic data includes data informative of a hit of the projectile (which indicates that the shock waves will not be detectable in the acoustic data), then the processing circuitry 130 instructs to perform the method of FIG. 4C or of FIG. 4I.

Reverting to the method of FIG. 4C, in order to identify the data D_{acoustic_impact} informative of a sound generated by an impact of the projectile, various methods can be used.

In some embodiments, a database stores a plurality of acoustic patterns which are characteristics of an impact of projectiles of interest (e.g., bullets, etc.) on different types of targets. Note that these acoustic patterns are selected to be informative of an impact of a projectile which occurred at an impact location which has a distance from the acoustic sensors which meets a proximity criterion (e.g., less than a few meters).

The processing circuitry 130 performs a comparison between these patterns and the acoustic data in order to identify whether an impact of the projectile on a target has occurred.

In some embodiments, a machine learning model (see reference 135 in FIG. 1) can be used. This is illustrated in the non-limitative example of FIG. 4E.

The acoustic data provided by the acoustic sensors 120, or data informative thereof, is fed to the machine learning model 135.

The machine learning model 135 has been trained to detect, in an acoustic signal, an event corresponding to an impact of a projectile on an obstacle.

In particular, the machine learning model 135 has been trained to detect, in an acoustic signal, an event corresponding to an impact of a projectile on an obstacle which is located at a distance D_{obstacle} from the acoustic sensors which meets a proximity criterion (e.g., less than a few meters).

The machine learning model 135 is therefore used to identify, in the acoustic data, data D_{acoustic_impact} informative of an event corresponding to an impact of the projectile.

Note that the acoustic data sensed by the acoustic sensors 120 over time can be fed in real time or quasi real time. For each piece of data 480₁, 480₂, 480₃ (etc.) of the acoustic data (each piece of data corresponds to a fraction of the acoustic data over a predefined period of time), the machine learning model 135 can output a prospect (a probability) that the piece of data includes an acoustic event corresponding to an impact of the projectile. When the probability is above a threshold, this indicates that the acoustic event can be considered as an impact of the projectile, which corresponds to D_{acoustic_impact}.

FIG. 4F describes a method of training the machine learning model 135. The method can be performed by a processing circuitry (such as processing circuitry 130). The method includes obtaining (operation 490) a training set comprising a plurality of acoustic data.

Some of the acoustic data includes an acoustic event corresponding to an impact of a projectile on an obstacle (or target). In some embodiments, the obstacle is located at a distance from the acoustic sensors which meets the proximity criterion. This corresponds to the “positive examples”.

Some of the acoustic data do not include an acoustic event corresponding to an impact of a projectile on an obstacle (or target). This corresponds to the “negative examples”.

In some embodiments, the training includes supervised or semi-supervised learning. Each acoustic data is associated with a label, indicative of whether it includes an acoustic event corresponding to an impact of a projectile on an obstacle (and, in some embodiments, the time of the impact within the acoustic data). The label can be provided e.g., by an operator. This is not limitative, and the training can also include automatic training and/or non-supervised learning.

The training set is then used (operation 491) to train the machine learning model 135 to predict, based on an input including acoustic data, whether it includes an acoustic event corresponding to an impact of a projectile.

According to some embodiments, the training set includes acoustic events corresponding to an impact of a projectile, for different types of projectiles (e.g., different calibers, different weight, different shapes, etc.).

According to some embodiments, the training set includes acoustic events corresponding to an impact of a projectile on an obstacle, for different types of materials of the obstacle (e.g., impact of the projectile on a metallic obstacle, impact of the projectile on an obstacle including glass, etc.).

According to some embodiments, a plurality of machine learning models is used. Each machine learning model is trained to detect an acoustic event corresponding to an impact of a projectile on an obstacle which includes a different type of material. For example, the first machine learning model is trained to detect an acoustic event corresponding to an impact on metal, the second machine learning model is trained to detect an acoustic event corresponding to an impact on glass, etc.

At operation 470, the acoustic data can be fed to each of the plurality of machine learning models. The output of the different machine learning models can be aggregated (using various methods such as averaging, voting method, etc.) to generate a decision of whether an impact of a projectile is present in the acoustic data. In some embodiments, the output of the different machine learning models can be used to estimate the type of material on which the impact has occurred.

The method further includes using (operation 480) D_{flash} and D_{acoustic_impact} to estimate the location of the projectile launch.

In other words, even if the shock waves generated by the projectile cannot be sensed by the acoustic sensors 120, it is possible to determine the location of the projectile launch.

Operation 480 can include (once the impact of the projectile has been identified), determining a corresponding time t_{impact} in the acoustic data. This time t_{impact} is an estimate of the time at which the impact of the projectile has occurred.

Operation 480 can include using t_{impact} to determine the location of the projectile launch.

The time at which the flash is sensed by the imaging device is noted time t_{flash} and is an estimate of the time t₀ of the projectile launch. t_{flash} can be used to estimate the location of the projectile launch.

In some embodiments, it can be assumed that the firing line direction is oriented towards the system, or close to it.

A series of the events is schematically illustrated in FIG. 4G.

According to some embodiments, operation 490 can include using t_{impact}, t_{flash} and parameters informative of a kinematic behavior of the projectile to estimate the location of the projectile launch. The parameters enable describing the flight of the projectile, such as drag, mass of the projectile, dimensions of the projectile, etc.

According to some embodiments, operation 490 can include using the following formula to determine the range R to the projectile:

t=t_{impact}−t_{flash}

$$R ( t ) = \frac{ln ( 1 + k t {v}_{0} )}{k}$$

$$k = \frac{1}{2 M} ρ {C}_{d} A$$

In this equation, M is the bullet mass, ρ is the air density, C_{d} is the drag coefficient of the projectile, A is the projectile cross-section and v₀ is an estimate of the velocity of the projectile (estimate of the muzzle velocity, which depends on the type of projectile).

Note that in some embodiments, the impact of the projectile can be detected even if the obstacle does not meet the proximity criterion. In this case, it is required to estimate the location of the obstacle, and this can be performed using e.g., an additional array of acoustic sensors (which can provide position using e.g. triangulation), or other methods.

Attention is now drawn to FIG. 4I, which can be used also when the shock waves cannot be detected by the acoustic sensors 120.

The method includes obtaining (operation 471) acoustic data from one or more acoustic sensors 120, wherein the data includes data D_{acoustic_impact} informative of a sound generated by an impact of the projectile and data D_{blast} informative of a sound generated by the projectile launch.

Embodiments for identifying the projectile impact and the blast in the acoustic data have already been described above.

The method further includes using (operation 481) D_{blast} and D_{acoustic_impact} to estimate the location of the projectile launch.

In other words, even if the shock waves generated by the projectile cannot be sensed by the acoustic sensors, it is possible to determine the location of the projectile launch.

Operation 481 can include (once the impact of the projectile has been identified), determining a corresponding time t_{impact} in the acoustic data. This time t_{impact} is an estimate of the time at which the impact of the projectile has occurred.

Operation 481 can include using t_{impact} to estimate the location of the projectile launch.

The time at which the blast is sensed by the acoustic sensors is noted time t_{blast}.

Operation 481 can include using t_{impact} and t_{blast} (time at which the blast has occurred or has been sensed by the acoustic sensors) to determine the location of the projectile launch.

According to some embodiments, operation 490 can include using t_{impact}, t_{blast} and a modelled kinematic behavior of the projectile to estimate the location of the projectile launch.

Note that this method can be also performed when the system 100 is mounted on a moving platform.

According to some embodiments, an iterative optimization process can be used at operation 490.

The method starts with the following estimate of the range R to the projectile (note that the direction to the projectile launch can be determined using D_{blast} from which the direction DR_{blast} can be determined):

$$R = \frac{{t}_{blast} - {t}_{impact}}{\frac{1}{{C}_{s o u n d}} - \frac{1}{{V}_{0}}}$$

In this equation, V₀ is an assumption on a constant velocity of the projectile (estimate of the muzzle velocity, which depends on the type of projectile).

The method further includes determining an expected time of flight (t_{impact}−t₀) of the projectile. t₀ is the time at which the projectile has been launched, which is unknown.

$${t}_{impact} - {t}_{0} = \frac{{e}^{k R} - 1}{k {V}_{0}}$$

This enables to determine t₀.

The method further includes estimating the time at which the blast is sensed by the acoustic sensors (based on the assumptions above):

$$\hat{{t}_{blast}} = \frac{R}{{c}_{s o u n d}} + {t}_{0}$$

The method further includes using a cost function which is informative of a difference between [symbol] (estimated time of the blast) and t_{blast} (measured time of the blast). The value of the range R which minimizes the cost function can be used as the estimate of the range to the projectile launch. This enables to determine the location of the projectile launch.

Attention is now drawn to FIG. 5A.

According to some embodiments, system 100 can be mounted on a moving platform 508, such as a vehicle.

Assume that a projectile 500 is launched at time t₀. The imaging device senses the muzzle flash when the moving platform 508 is located at position P₀, at time t_{flash}. However, the acoustic sensors sense the shock waves with a time delay (since the speed of sound is far slower than the speed of light). When the acoustic sensors sense the shock waves at time t_{shockwaves}, the moving platform 508 is located at position P₁, different from P₀.

The sensor 150 (see FIG. 1) can be used to determine the variation in the orientation/direction of the moving platform 508 (and in turn of the system 100) between the detection of the muzzle flash 510 and detection of the shock waves 525. In particular, the sensor 150 can be used to determine the change in the heading/direction (see θ) of the vehicle. Note that the distance between P₀ and P₁ can be generally neglected for the purpose of angular calculations.

This change θ in the heading of the system 100, together with the acoustic data provided by the acoustic sensors (D_{shockwaves}) and the data D_{flash} informative of the optical event associated with the projectile launch, can be used to determine the location of the projectile launch, using the methods described above, in which the variation θ will also be taken into account. In particular, the direction DR_{shockwaves} can be corrected by removing the change in the heading θ of the system 100 between the position at which the flash is detected and the position at which the shock waves are detected.

The same principle applies to the blast, for which the change θ′ in the heading of the system 100 can be taken into account to correct the direction DR_{blast}. Note that θ can differ from θ′ since the shock waves are received before the blast.

In particular, the sensor 150 can be used in the method of FIG. 4H, in order to take into account the fact that the system has a different heading/direction between sensing of the shock waves and sensing of the blast.

The invention contemplates a computer program being readable by a computer for executing at least part of one or more methods of the invention. The invention further contemplates a machine-readable memory tangibly embodying a program of instructions executable by the machine for executing at least part of one or more methods of the invention.

The terms “computer” or “computerized system” (such as computerized system 100) should be expansively construed to include any kind of hardware-based electronic device with a processing circuitry (e.g., digital signal processor (DSP), a GPU, a TPU, a field programmable gate array (FPGA), an application specific integrated circuit (ASIC), microcontroller, microprocessor etc.).

The processing circuitry (such as processing circuitry 130) can comprise, for example, one or more processors operatively connected to computer memory, loaded with executable instructions for executing operations, as further described below. The processing circuitry encompasses a single processor or multiple processors, which may be located in the same geographical zone, or may, at least partially, be located in different zones, and may be able to communicate together. The one or more processors can represent one or more general-purpose processing devices such as a microprocessor, a central processing unit, or the like. More particularly, a given processor may be one of: a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

It is to be noted that while the present disclosure refers to the processing circuitry 130 (or other processing circuitries) being configured to perform various functionalities and/or operations, the functionalities/operations can be performed by the one or more processors of the processing circuitry 130 in various ways. By way of example, the operations described hereinafter can be performed by a specific processor, or by a combination of processors. The operations described hereinafter can thus be performed by respective processors (or processor combinations) in the processing circuitry 130 (or other processing circuitries), while, optionally, at least some of these operations may be performed by the same processor. The present disclosure should not be limited to be construed as one single processor always performing all the operations.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM), or Rambus DRAM (RDRAM), etc.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

In embodiments of the presently disclosed subject matter, fewer, more, and/or different stages than those shown in the methods described in the appended figures may be executed. In embodiments of the presently disclosed subject matter, one or more stages illustrated in the methods described in the appended figures may be executed in a different order, and/or one or more groups of stages may be executed simultaneously.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A system operative to estimate a location of a projectile launch, the system comprising one or more processing circuitries configured to:
obtain, from an imaging device, data D_{flash} informative of an optical event associated with the projectile launch,
obtain, from acoustic sensors, acoustic data, wherein the acoustic data includes data D_{shockwaves} informative of shock waves generated by a motion of the projectile, and
use D_{flash} and D_{shockwaves} to estimate the location of the projectile launch.

2. The system of claim 1, configured to estimate the two-dimensional or the three-dimensional location of the projectile launch.

3. The system of claim 1 or of claim 2, configured to:
use D_{shockwaves} to estimate a time t_{shockwaves} at which at least some of the shock waves are sensed by the acoustic sensors, and
use t_{shockwaves} to estimate the location of the projectile launch.

4. The system of any one of claims 1 to 3, configured to:
use D_{shockwaves} to determine a direction DR_{shockwaves} at which at least some of the shock waves are sensed by the acoustic sensors, and
use DR_{shockwaves} to estimate the location of the projectile launch.

5. The system of claim 4, configured to:
obtain:
a reference acoustic pattern modelling shock waves sensed by the acoustic sensors, and
for each given candidate direction of a plurality of candidate directions of the shock waves at which shock waves are sensed by the acoustic sensors, one or more time delays modelling a time difference of sensing of the shock waves between the acoustic sensors,
use the reference acoustic pattern, the one or more time delays and D_{shockwaves} to determine the direction DR_{shockwaves}.

6. The system of any one of claims 1 to 5, configured to:
use data D_{flash} to obtain a time t_{flash} which is an estimate of a time t₀ at which the projectile has been launched, and
use the time t_{flash} to estimate the location of the projectile launch.

7. The system of any one of claims 1 to 6, configured to:
use data D_{flash} to estimate a direction DR_{flash} at which the projectile has been launched, and
use the direction DR_{flash} to estimate the location of the projectile launch.

8. The system of any one of claims 1 to 7, wherein the system is operative to determine the location of the projectile launch based on D_{flash} and D_{shockwaves} in at least one of (i) or (ii) is met:
(i) a scenario in which a blast generated by the projectile launch is sensed by the acoustic sensors with a frequency which is below a detection threshold;
(ii) a scenario in which a blast generated by the projectile launch is sensed by the acoustic sensors with a signal to noise ratio which is below a detection threshold.

9. The system of claim 8, wherein at least one of (i) or (ii) is met:
(i) the detection threshold is equal to 1 kHz;
(ii) when the blast generated by the projectile launch is sensed by the one or more acoustic sensors with a frequency equal to or below said detection threshold, or with a signal to noise ratio which is below a detection threshold, said blast cannot be identified in the acoustic data provided by the acoustic sensors.

10. The system of any one of claims 1 to 9, wherein the imaging device includes a plurality of light photodiodes.

11. The system of any one of claims 1 to 10, configured to use a model to estimate the location of the projectile launch, wherein the model is operative to estimate, for a given location of the projectile launch, a time \hat{t}_{shockwaves} and a direction [symbol] _{shockwaves} at which the shock waves are sensed by the acoustic sensors.

12. The system of any one of claims 1 to 11, configured to:
use a model to estimate, for each of one or more candidate locations of the projectile launch, a time \hat{t}_{shockwaves} and a direction [symbol] _{shockwaves} at which the shock waves are sensed by the acoustic sensors,
use D_{shockwaves} to determine a time t_{shockwaves} and a direction DR_{shockwaves} at which at least some of the shock waves are sensed by the acoustic sensors, and
use D_{shockwaves}, t_{shockwaves}, [symbol] _{shockwaves} and \hat{t}_{shockwaves} to estimate the location of the projectile launch.

13. The system of claim 11 or of claim 12, configured to:
use a model to estimate, for a plurality of candidate locations of the projectile launch, a time \hat{t}_{shockwaves} and a direction [symbol] _{shockwaves} at which the shock waves are sensed by the acoustic sensors, and
use:
DR shockwaves' t_{shockwaves}, and [symbol]
_{shockwaves} and \hat{t}_{shockwaves} determined for the plurality of candidate locations,
to determine a given candidate location of the projectile which meets an optimization criterion.

14. The system of any one of claims 11 to 13, wherein the model uses:
a modelled kinematic behavior of the projectile;
an estimate \hat{P}_{launch} of the location of the projectile launch;
a time t_{flash}, which is an estimate of a time t₀ at which the projectile has been launched, wherein t_{flash} has been determined using data D_{flash}; and
a direction DR_{flash}, which is an estimate of a direction of the projectile launch, wherein DR_{flash} has been determined using data D_{flash}.

15. The system of any one of claims 1 to 14, wherein the one or more processing circuitries are configured to implement at least one machine learning model, wherein the one or more processing circuitries are configured to:
feed the acoustic data, or data informative thereof, to the machine learning model,
use the machine learning model to identify, in the acoustic data, data D_{shockwaves} informative of shock waves generated by a motion of the projectile.

16. The system of claim 15, wherein (i) or (ii) is met:
(i) the machine learning model has been trained to detect, for each given type of a plurality of different types of projectiles, in acoustic data, an event corresponding to shock waves generated by a motion of a projectile of said given type;
(ii) the one or more processing circuitries are configured to implement a first machine learning model and a second machine learning model, wherein the first machine learning model has been trained to detect, in acoustic data, an event corresponding to shock waves generated by a motion of a projectile of a first type, and the second machine learning model has been trained to detect, in acoustic data, an event corresponding to shock waves generated by a motion of a projectile of a second type, different from the first type.

17. The system of any one of claims 1 to 16, wherein the optical event is a muzzle flash associated with the projectile launch.

18. The system of any one of claims 1 to 17, wherein the projectile is a supersonic projectile.

19. The system of any one of claims 1 to 18, comprising an electronic card embedding the imaging device, the acoustic sensors, and the one or more processing circuitries.

20. The system of any one of claims 1 to 19, further comprising at least one of (i) or (ii):
(i) the imaging device;
(ii) the acoustic sensors.

21. The system of any one of claims 1 to 20, wherein the acoustic data includes data D_{blast} informative of a blast generated by the projectile launch, wherein the system is configured to use D_{flash}, D_{shockwaves} and D_{blast} to estimate the location of the projectile launch, and a firing line direction of the projectile.

22. The system of claim 21, configured to:
use D_{flash} and D_{blast} to estimate the location \hat{P}_{launch} of the projectile launch,
use a model to estimate, for the location \hat{P}_{launch} of the projectile launch and one or more candidate firing line directions of the projectile, a time \hat{t}_{shockwaves} and a direction [symbol] _{shockwaves} at which the shock waves are sensed by the acoustic sensors,
use D_{shockwaves} to determine a time t_{shockwaves} and a direction DR_{shockwaves} at which at least some of the shock waves are sensed by the acoustic sensors,
use:
DR_{shockwaves}, t_{shockwaves}, and [symbol]
_{shockwaves} and \hat{t}_{shockwaves} determined for the one or more candidate firing line directions of the projectile,
to estimate the firing line direction of the projectile.

23. The system of any of claims 1 to 22, configured to:
perform a determination of a content of the acoustic data, wherein said determination enables to identify whether the acoustic data includes (i) or (ii):
(i) data D_{shockwaves} informative of shock waves generated by a motion of the projectile shock waves, wherein a blast generated by the projectile launch cannot be identified in the acoustic data,
(ii) data D_{shockwaves} informative of shock waves generated by a motion of the projectile shock waves and data D_{blast} informative of a blast generated by the projectile launch, and
trigger an estimation method of the location of the projectile launch which depends on this determination.

24. The system of any one of claims 1 to 23, wherein the system is operative to be mounted on a moving platform, wherein the system comprises, or is operatively coupled to a sensor operative to provide data Dᵢₙₑᵣₜᵢₐₗ informative of a direction of the moving platform or of the system over time.

25. The system of claim 24, configured to use D_{flash}, D_{shockwaves} and Dᵢₙₑᵣₜᵢₐₗ to estimate the location of the projectile launch.

26. The system of any one of claims 1 to 25, wherein the system is mounted on at least one of: a military vehicle, a tank, an aircraft.

27. A platform comprising a system operative to estimate a location of a projectile launch, the system comprising:
an imaging device,
acoustic sensors, and
one or more processing circuitries configured to:
obtain, from the imaging device, data D_{flash} informative of an optical event associated with the projectile launch,
obtain, from the acoustic sensors, acoustic data, wherein the acoustic data includes data D_{shockwaves} informative of shock waves generated by a motion of the projectile, and
use D_{flash} and D_{shockwaves} to estimate the location of the projectile launch.

28. A system operative to estimate a location of projectile launch, the system comprising one or more processing circuitries configured to:
obtain, from an imaging device, data D_{flash} informative of an optical event associated with the projectile launch,
obtain, from acoustic sensors, acoustic data, wherein the acoustic data includes:
data D_{shockwaves} informative of shock waves generated by a motion of the projectile, and
data D_{blast} informative of a blast generated by the projectile launch,
use D_{flash}, D_{shockwaves} and D_{blast} to estimate:
the location of the projectile launch, and
a firing line direction of the projectile.

29. The system of claim 28, configured to use a model which estimates, for a given location of the projectile launch and a given firing line direction of the projectile, a time \hat{t}_{shockwaves} and a direction [symbol] _{shockwaves} at which the shock waves are sensed by the acoustic sensors.

30. The system of claim 28 or of claim 29, wherein the one or more processing circuitries are configured to implement at least one machine learning model, wherein the one or more processing circuitries are configured to:
feed the acoustic data, or data informative thereof, to the machine learning model,
use the machine learning model to identify, in the acoustic data, data D_{shockwaves} informative of shock waves generated by a motion of the projectile and data D_{blast} informative of a blast generated by the projectile launch.

31. The system of any one of claims 28 to 30, wherein the one or more processing circuitries are configured to:
use D_{flash} and D_{blast} to estimate the location \hat{P}_{launch} of the projectile launch,
use a model to estimate, for the location \hat{P}_{launch} of the projectile launch and each of one or more candidate firing line directions of the projectile, a time \hat{t}_{shockwaves} and a direction [symbol] _{shockwaves} at which the shock waves are sensed by the acoustic sensors,
use D_{shockwaves} to determine a time t_{shockwaves} and a direction DR_{shockwaves} at which at least some of the shock waves are sensed by the acoustic sensors,
use:
DR_{shockwaves}, t_{shockwaves}, and [symbol]
_{shockwaves} and \hat{t}_{shockwaves} determined for the one or more candidate firing line directions of the projectile,
to estimate the firing line direction of the projectile.

32. A system operative to estimate a location of a projectile launch, the system comprising one or more processing circuitries configured to:
obtain, from an imaging device, data D_{flash} informative of an optical event associated with the projectile launch,
obtain, from acoustic sensors, acoustic data, wherein the acoustic data includes data D_{acoustic_impact} informative of a sound generated by an impact of the projectile, and
use data D_{flash} and data D_{acoustic_impact} to estimate the location of the projectile launch.

33. The system of claim 32, configured to:
use D_{acoustic_impact} to determine a time t_{impact} which is an estimate of a time at which the impact of the projectile has occurred, and
use t_{impact} to estimate the location of the projectile launch.

34. The system of claim 32 or of claim 33, configured to:
use data D_{flash} to obtain a time t_{flash} which is an estimate of a time t₀ at which the projectile has been launched, and
use the time t_{flash} to estimate the location of the projectile launch.

35. The system of any one of claims 32 to 34, configured to:
use data D_{flash} to estimate a direction DR_{flash} at which the projectile has been launched, and
use the direction DR_{flash} to estimate the location of the projectile launch.

36. The system of any one of claims 32 to 35, configured to:
use D_{acoustic_impact} to determine a time t_{impact} which is an estimate of a time at which the impact of the projectile has occurred,
use data D_{flash} to obtain a time t_{flash} which is an estimate of a time t₀ at which the projectile has been launched, and
use t_{impact}, t_{flash} and parameters informative of a kinematic behavior of the projectile to estimate the location of the projectile launch.

37. The system of any one of claims 32 to 36, operative to determine the location of the projectile launch based on D_{flash} and D_{acoustic_impact} in at least one of (i) or (ii):
(i) a scenario in which shock waves generated by a motion of the projectile are not sensed by the acoustic sensors;
(ii) a scenario in which the projectile is a subsonic projectile.

38. The system of any one of claims 32 to 37, wherein the system is operative to be mounted on a moving platform, wherein the system comprises, or is operatively coupled to a sensor operative to provide data Dᵢₙₑᵣₜᵢₐₗ informative of a direction of the moving platform or of the system over time, wherein the system is configured to use Dᵢₙₑᵣₜᵢₐₗ to estimate the location of the projectile launch.

39. The system of any one of claims 32 to 38, wherein the one or more processing circuitries are configured to implement at least one machine learning model, wherein the one or more processing circuitries are configured to:
feed the acoustic data, or data informative thereof, to the machine learning model,
use the machine learning model to identify, in the acoustic data, data D_{acoustic_impact} informative of a sound generated by an impact of the projectile.

40. The system of any one of claims 32 to 39, wherein the one or more processing circuitries are configured to implement at least one machine learning model, wherein the one or more processing circuitries are configured to:
feed the acoustic data, or data informative thereof, to the machine learning model,
use the machine learning model to identify, in the acoustic data, data D_{acoustic_impact} informative of a sound generated by an impact of the projectile at an impact location which is located at a distance from the acoustic sensors which meets a proximity criterion.

41. A platform comprising a system operative to estimate a location of a projectile launch, the system comprising:
an imaging device,
acoustic sensors, and
one or more processing circuitries configured to:
obtain, from the imaging device, data D_{flash} informative of an optical event associated with the projectile launch,
obtain, from the acoustic sensors, acoustic data, wherein the acoustic data includes data D_{acoustic_impact} informative of a sound generated by an impact of the projectile, and
use data D_{flash} and data D_{acoustic_impact} to estimate the location of the projectile launch.

42. A system operative to estimate a location of a projectile launch, the system comprising one or more processing circuitries configured to:
obtain, from acoustic sensors, acoustic data, wherein the acoustic data includes data D_{acoustic_impact} informative of a sound generated by an impact of the projectile, and data D_{blast} informative of a blast generated by the projectile launch,
use D_{acoustic_impact} and D_{blast} to estimate the location of the projectile launch.

43. The system of claim 42, configured to:
use D_{acoustic_impact} to determine a time t_{impact} which is an estimate of a time at which the impact of the projectile has occurred,
use D_{blast} to determine a time t_{blast} at which the blast has been sensed by the acoustic sensors, and
use t_{impact} and t_{blast} to estimate the location of the projectile launch.

44. A system operative to estimate a location of projectile launch, the system comprising one or more processing circuitries configured to:
obtain, from an imaging device, data D_{flash} informative of an optical event associated with the projectile launch,
obtain, from acoustic sensors, acoustic data;
perform a determination of a content of the acoustic data, wherein:
when the determination indicates that the acoustic data includes data D_{shockwaves} informative of shock waves generated by a motion of the projectile, but a blast associated with the projectile launch cannot be identified in the acoustic data, use D_{flash} and D_{shockwaves} to estimate the location of the projectile launch;
when the determination indicates that the acoustic data includes data D_{acoustic_impact} informative of a sound generated by an impact of the projectile, use data D_{flash} and data D_{acoustic_impact} to estimate the location of the projectile launch;
when the determination indicates that the acoustic data includes data D_{acoustic_impact} informative of a sound generated by an impact of the projectile and data D_{blast} informative of a blast generated by the projectile launch, use data D_{flash} and data D_{acoustic_impact} to estimate the location of the projectile launch, or data D_{blast} and data D_{acoustic_impact} to estimate the location of the projectile launch.

45. The system of claim 44, wherein, when the determination indicates that the acoustic data D_{shockwaves} informative of shock waves generated by a motion of the projectile the projectile and data D_{blast} informative of a blast generated by the projectile launch, use D_{flash}, D_{shockwaves} and D_{blast} to estimate the location of the projectile launch and a firing line direction of the projectile.

46. A method to estimate a location of a projectile launch, the method comprising, by one or more processing circuitries:
obtaining, from an imaging device, data D_{flash} informative of an optical event associated with the projectile launch,
obtaining, from acoustic sensors, acoustic data, wherein the acoustic data includes data D_{shockwaves} informative of shock waves generated by a motion of the projectile, and
using D_{flash} and D_{shockwaves} to estimate the location of the projectile launch.

47. A method to estimate a location of projectile launch, the method comprising, by one or more processing circuitries:
obtaining, from an imaging device, data D_{flash} informative of an optical event associated with the projectile launch,
obtaining, from acoustic sensors, acoustic data, wherein the acoustic data includes:
data D_{shockwaves} informative of shock waves generated by a motion of the projectile, and
data D_{blast} informative of a blast generated by the projectile launch,
using D_{flash}, D_{shockwaves} and D_{blast} to estimate:
the location of the projectile launch, and
a firing line direction of the projectile.

48. A method to estimate a location of a projectile launch, the method comprising, by one or more processing circuitries:
obtaining, from an imaging device, data D_{flash} informative of an optical event associated with the projectile launch,
obtaining, from acoustic sensors, acoustic data, wherein the acoustic data includes data D_{acoustic_impact} informative of a sound generated by an impact of the projectile, and
using data D_{flash} and data D_{acoustic_impact} to estimate the location of the projectile launch.

49. A method to estimate a location of a projectile launch, the method comprising, by one or more processing circuitries:
obtaining, from acoustic sensors, acoustic data, wherein the acoustic data includes data D_{acoustic_impact} informative of a sound generated by an impact of the projectile, and data D_{blast} informative of a blast generated by the projectile launch,
using D_{acoustic_impact} and D_{blast} to estimate the location of the projectile launch.

50. A method to estimate a location of projectile launch, the method comprising, by one or more processing circuitries:
obtaining, from an imaging device, data D_{flash} informative of an optical event associated with the projectile launch,
obtaining, from acoustic sensors, acoustic data;
performing a determination of a content of the acoustic data, wherein:
when the determination indicates that the acoustic data includes data D_{shockwaves} informative of shock waves generated by a motion of the projectile, but a blast associated with the projectile launch cannot be identified in the acoustic data, use D_{flash} and D_{shockwaves} to estimate the location of the projectile launch;
when the determination indicates that the acoustic data includes data D_{acoustic_impact} informative of a sound generated by an impact of the projectile, use data D_{flash} and data D_{acoustic_impact} to estimate the location of the projectile launch;
when the determination indicates that the acoustic data includes data D_{acoustic_impact} informative of a sound generated by an impact of the projectile and data D_{blast} informative of a blast generated by the projectile launch, use data D_{flash} and data D_{acoustic_impact} to estimate the location of the projectile launch, or data D_{blast} and data D_{acoustic_impact} to estimate the location of the projectile launch.

51. A non-transitory computer readable medium comprising instructions that, when executed by one or more processing circuitries, cause the one or more processing circuitries to perform:
obtaining, from an imaging device, data D_{flash} informative of an optical event associated with a projectile launch,
obtaining, from acoustic sensors, acoustic data, wherein the acoustic data includes data D_{shockwaves} informative of shock waves generated by a motion of the projectile, and
using D_{flash} and D_{shockwaves} to estimate location of the projectile launch.

52. A non-transitory computer readable medium comprising instructions that, when executed by one or more processing circuitries, cause the one or more processing circuitries to perform:
obtaining, from an imaging device, data D_{flash} informative of an optical event associated with a projectile launch,
obtaining, from acoustic sensors, acoustic data, wherein the acoustic data includes:
data D_{shockwaves} informative of shock waves generated by a motion of the projectile, and
data D_{blast} informative of a blast generated by the projectile launch,
using D_{flash}, D_{shockwaves} and D_{blast} to estimate:
location of the projectile launch, and
a firing line direction of the projectile.

53. A non-transitory computer readable medium comprising instructions that, when executed by one or more processing circuitries, cause the one or more processing circuitries to perform:
obtaining, from an imaging device, data D_{flash} informative of an optical event associated with a projectile launch,
obtaining, from acoustic sensors, acoustic data, wherein the acoustic data includes data D_{acoustic_impact} informative of a sound generated by an impact of the projectile, and
using data D_{flash} and data D_{acoustic_impact} to estimate location of the projectile launch.

54. A non-transitory computer readable medium comprising instructions that, when executed by one or more processing circuitries, cause the one or more processing circuitries to perform:
obtaining, from acoustic sensors, acoustic data, wherein the acoustic data includes data D_{acoustic_impact} informative of a sound generated by an impact of the projectile, and data D_{blast} informative of a blast generated by a projectile launch,
using D_{acoustic_impact} and D_{blast} to estimate location of the projectile launch.

55. A non-transitory computer readable medium comprising instructions that, when executed by one or more processing circuitries, cause the one or more processing circuitries to perform:
obtaining, from an imaging device, data D_{flash} informative of an optical event associated with a projectile launch,
obtaining, from acoustic sensors, acoustic data;
performing a determination of a content of the acoustic data, wherein:
when the determination indicates that the acoustic data includes data D_{shockwaves} informative of shock waves generated by a motion of the projectile, but a blast associated with the projectile launch cannot be identified in the acoustic data, use D_{flash} and D_{shockwaves} to estimate the location of the projectile launch;
when the determination indicates that the acoustic data includes data D_{acoustic_impact} informative of a sound generated by an impact of the projectile, use data D_{flash} and data D_{acoustic_impact} to estimate the location of the projectile launch;
when the determination indicates that the acoustic data includes data D_{acoustic_impact} informative of a sound generated by an impact of the projectile and data D_{blast} informative of a blast generated by the projectile launch, use data D_{flash} and data D_{acoustic_impact} to estimate the location of the projectile launch, or data D_{blast} and data D_{acoustic_impact} to estimate the location of the projectile launch.
